(19) United States
(12) Patent Application Publication
(10) Pub. No.: US 2026/0043988 A1
(43) Pub. Date: Feb. 12, 2026

(54) IMAGING LENS SYSTEM

(71) Applicant: Samsung Electro-Mechanics Co., Ltd., Suwon-si (KR)

(72) Inventors: Hag Chul KIM, Suwon-si (KR); Seong Il CHO, Suwon-si (KR)

(73) Assignee: Samsung Electro-Mechanics Co., Ltd., Suwon-si (KR)

(21) Appl. No.: 19/046,138

(22) Filed: Feb. 5, 2025

(30) Foreign Application Priority Data
Aug. 7, 2024 (KR) 10-2024-0105343

(51) Int. Cl. G02B 13/00; G02B 15/14

(52) U.S. Cl. CPC G02B 13/0045; G02B 13/0065; G02B 13/009; G02B 15/143503

(57) ABSTRACT

An imaging lens system includes a first lens group comprising a first lens and a second lens; a second lens group comprising a third lens, a fourth lens, and a fifth lens; and a third lens group comprising a sixth lens, a seventh lens, and an eighth lens, wherein the first lens group to the third lens group are sequentially arranged in ascending numerical order along an optical axis of the imaging lens system from an object side of the imaging lens system toward an imaging plane of the imaging lens system, and the imaging lens system satisfies the conditional expression 2.0<TTL/2ImgHT<3.0, where TTL is a distance along the optical axis from an object-side surface of the first lens to the imaging plane, and 2ImgHT is a diagonal length of the imaging plane.

### CROSS-REFERENCE TO RELATED APPLICATIONS

This application claims the benefit under 35 USC 119 (a) of Korean Patent Application No. 10-2024-0105343 filed on Aug. 7, 2024, in the Korean Intellectual Property Office, the entire disclosure of which is incorporated herein by reference for all purposes.

### BACKGROUND

### 1. Field

The present disclosure relates to an imaging lens system configured to improve a resolution of a peripheral portion of an imaging plane.

### 2. Description of Background

A camera module can be mounted in an electronic device configured to capture a still image or to record a moving image. For example, a camera module can be mounted on a mobile phone, a laptop, a game console, or the other electronic device.

As the performance of electronic devices having camera modules mounted therein increases, camera modules with a high performance and a high resolution while having a small size are needed. For example, to implement a high-performance camera module, an imaging lens system with a high magnification (zoom) performance is required. However, the imaging lens systems with a high magnification performance have a problem in which a resolution of a peripheral portion of an imaging plane is significantly lower than a resolution at a center portion of the imaging plane around the optical axis.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

Other features and aspects will be apparent from the following detailed description, the drawings, and the claims.

### BRIEF DESCRIPTION OF DRAWINGS

FIG. 1 is a configuration diagram of an imaging lens system according to a first embodiment of the present disclosure.

FIGS. 2 and 3 are aberration curves of the imaging lens system illustrated in FIG. 1.

FIG. 4 is a configuration diagram of an imaging lens system according to a second embodiment of the present disclosure.

FIGS. 5 and 6 are aberration curves of the imaging lens system illustrated in FIG. 4.

FIG. 7 is a configuration diagram of an imaging lens system according to a third embodiment of the present disclosure.

FIGS. 8 and 9 are aberration curves of the imaging lens system illustrated in FIG. 7.

FIG. 10 is a configuration diagram of an imaging lens system according to a fourth embodiment of the present disclosure.

FIGS. 11 and 12 are aberration curves of the imaging lens system illustrated in FIG. 10.

FIG. 13 is a configuration diagram of an imaging lens system according to a fifth embodiment of the present disclosure.

FIGS. 14 and 15 are aberration curves of the imaging lens system illustrated in FIG. 13.

FIG. 16 is a configuration diagram of an imaging lens system according to a sixth embodiment of the present disclosure.

FIGS. 17 and 18 are aberration curves of the imaging lens system illustrated in FIG. 16.

FIG. 19 is a configuration diagram of an imaging lens system according to a seventh embodiment of the present disclosure.

FIGS. 20 and 21 are aberration curves of the imaging lens system illustrated in FIG. 19.

FIG. 22 is a configuration diagram of an imaging lens system according to an eighth embodiment of the present disclosure.

FIGS. 23 and 24 are aberration curves of the imaging lens system illustrated in FIG. 22.

FIG. 25 is a configuration diagram of an imaging lens system according to a ninth embodiment of the present disclosure.

FIGS. 26 and 27 are aberration curves of the imaging lens system illustrated in FIG. 25.

FIG. 28 is a configuration diagram of an imaging lens system according to a tenth embodiment of the present disclosure.

FIGS. 29 and 30 are aberration curves of the imaging lens system illustrated in FIG. 28.

FIG. 31 is an electronic device in which an imaging lens system according to an embodiment of the present disclosure is mounted.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

In lens configuration diagrams in the figures of the present application, a thickness, a size, and a shape of a lens may be somewhat exaggerated for ease of explanation, and in particular, a spherical shape or an aspherical shape shown in the lens configuration diagram is only illustrative, and is not limited to the shape shown.

In the present specification, a first lens refers to a lens most closely disposed to an object (or a subject), and an eighth lens refers to a lens most closely disposed to an imaging plane (or an image sensor).

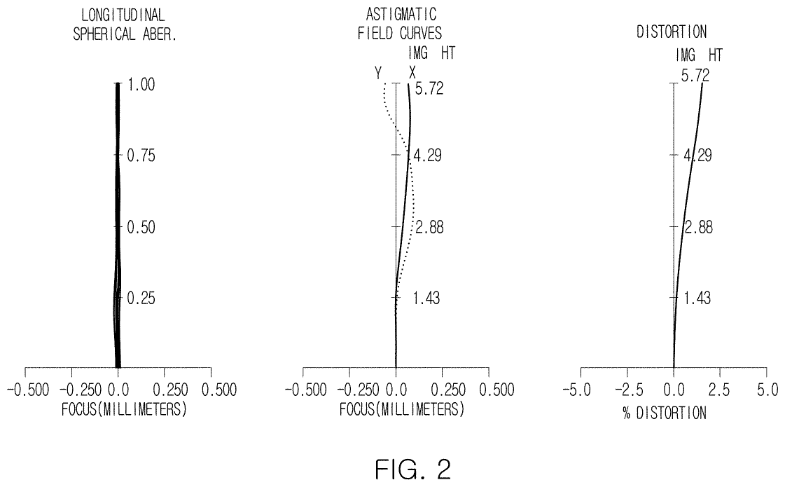

In the present specification, units of a radius of curvature, a thickness, a distance from an object-side surface of the first lens to an imaging plane (TTL), a distance from an image-side of the eighth lens to the imaging plane (BFL), a height of an imaging plane (ImgHT), a focal length, and a gap between lenses are indicated in millimeters (mm). FIGS. 2, 3, 5, 6, 8, 9, 11, 12, 14, 15, 17, 18, 20, 21, 23, 24, 26, 27, 29, and 30 list “IMG HT” rather than “ImgHT, but the two terms mean the same thing.

A thickness of a lens, a gap between lenses, TTL, and BFL refer to a distance measured along an optical axis.

Also, in the descriptions of a shape of a lens, a statement that one surface of a lens is convex means that a paraxial region of the surface is convex, and a statement that one surface of a lens is concave means that a paraxial region of the surface is concave. Thus, even when it is stated that one surface of a lens is convex, an edge portion of the lens may be concave. Similarly, even when it is stated that one surface of a lens is concave, an edge portion of the lens may be convex.

A paraxial region of a lens surface is a very narrow region of the lens surface near an optical axis of the lens surface. In greater detail, a paraxial region of a lens surface is a central portion of the lens surface surrounding and including the optical axis of the lens surface in which light rays incident to the lens surface make a small angle θ to the optical axis, and the approximations sin θ ≈θ, tan θ ≈θ, and cos θ≈1 are valid.

An imaging lens system according to a first aspect of the present disclosure may include a first lens group, a second lens group, and a third lens group sequentially arranged in ascending numerical order along an optical axis of the imaging lens system from an object side of the imaging lens system toward an imaging plane of the imaging lens system. In the imaging lens system according to the first aspect, the first lens group may include a first lens and a second lens, the second lens group may include a third lens, a fourth lens, and a fifth lens, and the third lens group may include a sixth lens, a seventh lens, and an eighth lens.

The imaging lens system according to the first aspect may satisfy a specific conditional expression. For example, the imaging lens system according to the first aspect may satisfy the conditional expression 2.0<TTL/2ImgHT <3.0. In the conditional expression, TTL is a distance along the optical axis from an object-side surface of the first lens to the imaging plane, and 2ImgHT is a diagonal length of the imaging plane.

An imaging lens system according to a second aspect of the present disclosure may include a first lens, a second lens, a third lens, a fourth lens, a fifth lens, a sixth lens, a seventh lens, and an eighth lens sequentially arranged in ascending numerical order along an optical axis of the imaging lens system from an object side of the imaging lens system toward an imaging plane of the imaging lens system. The imaging lens system according to the second aspect may include a plurality of lenses having a negative refractive power. For example, in the imaging lens system according to the second aspect, the first lens and the eighth lens may each have a negative refractive power.

The imaging lens system according to the second aspect may satisfy a specific conditional expression. For example, the imaging lens system according to the second aspect may satisfy the conditional expression 2.0<TTL/2ImgHT <3.0. In the conditional expression, TTL is a distance along the optical axis from a object-side surface of the first lens to the imaging plane, and 2ImgHT is a diagonal length of the imaging plane.

An imaging lens system according to a third aspect of the present disclosure may include a plurality of lens groups. For example, an imaging lens system according to the third aspect may include a first lens group, a second lens group, and a third lens group sequentially arranged in ascending numerical order along an optical axis of the imaging lens system from an object side of the imaging lens system toward an imaging plane of the imaging lens system.

The imaging lens system according to the third aspect may include at least one lens group configured to be drivable in a direction of the optical axis. For example, in the imaging lens system according to the third aspect, the second lens group and the third lens group may be configured to be drivable in a direction of the optical axis.

The imaging lens system according to the third aspect may include an aspherical glass lens. For example, in the imaging lens system according to the third aspect, the first lens group and the second lens group may each include one or more aspherical glass lenses. In the imaging lens system according to the third aspect, the second lens group and the third lens group may be comprised of a same number of lenses. For example, in the imaging lens system according to the third aspect, the second lens group and the third lens group may each be comprised of three lenses.

The imaging lens system according to the third aspect may continuously change a field of view (FOV) and a focal length (f) of the imaging lens system by moving the second lens group and the third lens group toward the object side of the imaging lens system or the imaging plane while maintaining a distance along the optical axis from an object-side surface of the first lens group to the imaging plane constant.

An imaging lens system according to a fourth aspect of the present disclosure may include first to eighth lenses sequentially arranged in ascending numerical order along an optical axis of the imaging lens system from an object side of the imaging lens system toward an imaging plane of the imaging lens system, and may satisfy any one or any combination of any two or more of the following Conditional Expressions 1 to 9.

$$- 5.0 < fw / f 6 < - 0 \text{.10} \qquad ( Conditional Expression 1 )$$

$$0.1 < fw / f 7 < 5. 0 \qquad ( Conditional Expression 2 )$$

$$- 5. < fw / f 8 < - 0.10 \qquad ( Conditional Expression 3 )$$

$$1.45 < Nd 3 < 1.50 \qquad ( Conditional Expression 4 )$$

$$- 5. < fw / R 10 < - 0.10 \qquad ( Conditional Expression 5 )$$

$$- 5. < fw / R 14 < - 0.10 \qquad ( Conditional Expression 6 )$$

$$2. < TTL / 2 ImgHT < 3. \qquad ( Conditional Expression 7 )$$

$$0.2 < BFLw / 2 ImgHT < 0.6 \qquad ( Conditional Expression 8 )$$

$$0.3 < TTL / fw < 1.70 \qquad ( Conditional Expression 9 )$$

In the above-described conditional expressions, fw is a focal length of the imaging lens system at a wide-angle end (or a first position of a lens group), f6 is a focal length of the sixth lens, f7 is a focal length of the seventh lens, f8 is a focal length of the eighth lens, Nd3 is a refractive index of the third lens, R10 is a radius of curvature of an image-side surface of the fifth lens, R14 is a radius of curvature of an image-side surface of the seventh lens, and BFLw is a distance from an image-side surface of the eighth lens to an imaging plane at the wide-angle end.

In the above-described conditional expressions, Conditional Expressions 1 to 3 may be numerical ranges for limiting the optical characteristics of the sixth to eighth lenses for improving performance of a peripheral portion of the imaging plane. For example, an imaging lens system satisfying one or more of the Conditional Expressions 1 to 3 may improve a resolution of the peripheral portion of the imaging plane to a level substantially equal to a resolution of a center portion of the imaging plane around the optical axis.

In the above-described conditional expressions, Conditional Expression 4 may be a numerical range for limiting the optical characteristics of a lens for improving a high-resolution chromatic aberration. For example, a third lens satisfying Conditional Expressions 4 may be advantageous in improving chromatic aberration because it may have low dispersion characteristics.

In the above-described conditional expressions, Conditional Expressions 5 and 6 may be numerical ranges for limiting the optical characteristics of the fifth and seventh lenses for improving field curvature aberration. For example, an imaging lens system satisfying either one or both of Conditional Expressions 5 and 6 may effectively improve field curvature aberration in the peripheral portion of the imaging plane.

In the above-described conditional expressions, Conditional Expressions 7 to 9 may be numerical ranges for achieving miniaturization of the imaging lens system. For example, an imaging lens system satisfying any one or any combination of any two or more of Conditional Expressions 7 to 9 may be miniaturized to facilitate installation in a portable terminal.

An imaging lens system according to a fifth aspect of the present disclosure may include a first lens group, a second lens group, and a third lens group sequentially arranged in ascending numerical order along an optical axis of the imaging lens system from an object side of the imaging lens system toward an imaging plane of the imaging lens system, and may satisfy any one or any combination of any two or more of the following Conditional Expressions 10 to 15.

$$- 3.20 < fG 1 F / fG 2 F < - 1 \text{.60} \qquad ( Conditional Expression 10 )$$

$$0.2 < fG 1 F / fG 3 F < 1.60 \qquad ( Conditional Expression 11 )$$

$$- 1.2 \; 0 < fG 2 F / fG 3 F < - 0.20 \qquad ( Conditional Expression 12 )$$

$$- 4.2 \; 0 < fG 1 R / fG 2 R < - 2.80 \qquad ( Conditional Expression 13 )$$

$$- 8. < fG 1 R / fG 3 R < - 4. \qquad ( Conditional Expression 14 )$$

$$1. < fG 2 R / fG 3 R < 2.40 \qquad ( Conditional Expression 15 )$$

In the above-described conditional expressions, fG1F is a focal length of a lens most closely disposed to an object in the first lens group, fG2F is a focal length of a lens most closely disposed to the object in the second lens group, fG3F is a focal length of a lens most closely disposed to the object in the third lens group, fG1R is a focal length of a lens most closely disposed to the imaging plane in the first lens group, fG2R is a focal length of a lens most closely disposed to the imaging plane in the second lens group, and fG3R is a focal length of a lens most closely disposed to the imaging plane in the third lens group.

The above-described conditional expressions may be numerical ranges for limiting a refractive power distribution of the first lens group to the third lens group. For example, an imaging lens system falling outside the numerical ranges of the above-described conditional expressions may deteriorate a resolution of the imaging lens system.

An imaging lens system according to a sixth aspect of the present disclosure may include a first lens group, a second lens group, and a third lens group sequentially arranged in ascending numerical order along an optical axis of the imaging lens system from an object side of the imaging lens system toward an imaging plane of the imaging lens system, and may satisfy any one or any combination of any two or more of the following Conditional Expressions 16 to 21.

$$1.6 < RG 1 F / RG 2 F < 7 \text{.20} \qquad ( Conditional Expression 16 )$$

$$- 3. < RG 1 F / RG 3 F < - 0.60 \qquad ( Conditional Expression 17 )$$

$$- 1. < RG 2 F / RG 3 F < - 0.20 \qquad ( Conditional Expression 18 )$$

$$- 1.6 \; 0 < rG 1 R / rG 2 R < - 0.80 \qquad ( Conditional Expression 19 )$$

$$1.2 < rG 1 R / rG 3 R < 2.40 \qquad ( Conditional Expression 20 )$$

$$- 2. < rG 2 R / rG 3 R < - 1.0 \qquad ( Conditional Expression 21 )$$

In the above-described conditional expressions RG1F is a radius of curvature of an object-side surface of a lens most closely disposed to an object in the first lens group, RG2F is a radius of curvature of an object-side surface of a lens most closely disposed to an object in the second lens group, RG3F is a radius of curvature of an object-side surface of a lens most closely disposed to an object in the third lens group, rG1R is a radius of curvature of an image-side surface of a lens most closely disposed to an imaging plane in the first lens group, rG2R is a radius of curvature of an image-side surface of a lens most closely disposed to an imaging plane in the second lens group, and rG3R is a radius of curvature of an image-side surface of a lens most closely disposed to an imaging plane in the third lens group.

The above-described conditional expressions may be numerical ranges for reducing aberrations of the first lens group to the third lens group. For example, a lens shape of the lens group falling outside the numerical ranges of the above-described conditional expressions may have increased aberrations of the imaging lens system.

An imaging lens system according to a seventh aspect of the present disclosure may include a first lens, a second lens, a third lens, a fourth lens, a fifth lens, a sixth lens, a seventh lens, and an eighth lens sequentially arranged in ascending numerical order along an optical axis of the imaging lens system from an object side of the imaging lens system toward an imaging plane of the imaging lens system, and may satisfy any one or any combination of any two or more of the following Conditional Expressions 22 to 24.

$$1. < ( R 2 + R 3 ) / R 4 < 2. \qquad ( Conditional Expression 22 )$$

$$0.2 < ( R 5 + R 6 ) / R 7 < 0.60 \qquad ( Conditional Expression 23 )$$

$$1. < ( R 8 + R 9 ) / R 10 < 2.0 \qquad ( Conditional Expression 24 )$$

In the above-described conditional expressions, R2 is a radius of curvature of an image-side surface of the first lens, R3 is a radius of curvature of an object-side surface of the second lens, R4 is a radius of curvature of an image-side surface of the second lens, R5 is a radius of curvature of an object-side surface of the third lens, R6 is a radius of curvature of an image-side surface of the third lens, R7 is a radius of curvature of an object-side surface of the fourth lens, R8 is a radius of curvature of an image-side surface of the fourth lens, R9 is a radius of curvature of an object-side surface of the fifth lens, and R10 is a radius of curvature of an image-side surface of the fifth lens.

The above-described conditional expressions may be a numerical range for reducing aberrations of the first to fifth lenses. For example, the first to fifth lenses falling outside the numerical range of the above-described conditional expressions may have increased aberrations of the imaging lens system.

An imaging lens system according to an eighth aspect of the present disclosure may include a plurality of lens groups. For example, an imaging lens system according to the eighth aspect may include a first lens group, a second lens group, and a third lens group sequentially arranged in ascending numerical order along an optical axis of the imaging lens system from an object side of the imaging lens system toward an imaging plane of the imaging lens system. The imaging lens system according to the eighth aspect may include a lens group configured to be drivable in a direction of the optical axis. For example, in the imaging lens system according to the eighth aspect, the second lens group and the third lens group may be configured to be drivable in the optical axis direction. In the imaging lens system according to the eighth aspect, the second lens group and the third lens group may be comprised of a same number of lenses. For example, in the imaging lens system according to the eighth aspect, the second lens group and the third lens group may each be comprised of three lenses.

The imaging lens system according to the eighth aspect may be configured to enable continuous focus magnification adjustment (zoom in and zoom out). For example, in the imaging lens system according to the eighth aspect, the first lens group and the third lens group may each have a negative refractive power, and the second lens group may have a positive refractive power. As another example, in the imaging lens system according to the eighth aspect, a focal length fG1 of the first lens group, a focal length fG2 of the second lens group, and a focal length fG3 of the third lens group may satisfy the following Conditional Expressions 25 and 26.

$$\vert 1 / fG 1 \vert < \vert 1 / fG 3 \vert \qquad ( Conditional Expression 25 )$$

$$\vert 1 / fG 3 \vert < \vert 1 / fG 2 \vert \qquad ( Conditional Expression 26 )$$

As another example, the imaging lens system according to the eighth aspect may satisfy any one or any combination of any two or more of the following Conditional Expressions 27 to 30.

$$- 4.60 < fG 1 / fG 2 < - 2 \text{.60} \qquad ( Conditional Expression 27 )$$

$$- 1.8 \; 0 < fG 3 / fG 2 < - 0.80 \qquad ( Conditional Expression 28 )$$

$$1.6 < fG 1 / fG 3 < 4. \qquad ( Conditional Expression 29 )$$

$$1. < ( fG 1 + fG 2 ) / fG 3 < 3.0 \qquad ( Conditional Expression 30 )$$

An imaging lens system according to a ninth aspect of the present disclosure may be configured to include any two or more of the features according to the first to eighth aspects. For example, an imaging lens system according to the ninth aspect may include the features of the first aspect and satisfy any one or any combination of any two or more of the conditional expressions according to the fourth to seventh aspects. As another example, an imaging lens system according to the ninth aspect may include the features of the eighth aspect while satisfying any one or any combination of any two or more of the conditional expressions according to the fourth to seventh aspects.

The imaging lens system according to the first to ninth aspects may include one or more lenses having the following characteristics as necessary. For example, the imaging lens system according to the first aspect may include one of the first to eighth lenses having the following characteristics. As another example, the imaging lens system according to the second aspect may include two or more of the first to eighth lenses having the following characteristics. However, the imaging lens system according to the above-described aspect may not necessarily include lenses having the following characteristics. The characteristics of the first to eighth lenses are described below.

The first lens may have a refractive power. For example, the first lens may have a negative refractive power. The first lens may have a convex shape on one surface. For example, the first lens may have a convex object-side surface. The first lens may have an aspherical shape. For example, both surfaces of the first lens may be aspherical. The first lens may be made of a material having a high light transmittance and an excellent processability. For example, the first lens may be made of a glass material. The first lens may have a predetermined refractive index. For example, the first lens may have a refractive index of 1.76 or more. The first lens may have a predetermined Abbe number. For example, the first lens may have an Abbe number of 40 or more.

The second lens may have a refractive power. For example, the second lens may have a positive refractive power. The second lens may have a convex shape on one surface. For example, the second lens may have a convex object-side surface. The second lens may have an aspherical shape. For example, both surfaces of the second lens may be aspherical. The second lens may be made of a material having a high light transmittance and an excellent processability. For example, the second lens may be made of a glass or a plastic material. The second lens may have a predetermined refractive index. For example, the second lens may have a refractive index of 1.65 or more.

The third lens may have a refractive power. For example, the third lens may have a positive refractive power. The third lens may have a convex shape on one surface. For example, the third lens may have a convex object-side surface. The third lens may have an aspherical shape. For example, both surfaces of the third lens may be aspherical. The third lens may be made of a material having a high light transmittance and an excellent processability. For example, the third lens may be made of a glass or a plastic material. The third lens may have a predetermined refractive index. For example, the third lens may have a refractive index of less than 1.6. The third lens may have a predetermined Abbe number. For example, the third lens may have an Abbe number of 80 or more.

The fourth lens may have a refractive power. For example, the fourth lens may have a positive refractive power. The fourth lens may have a concave shape on one surface. For example, the fourth lens may have a concave object-side surface. The fourth lens may have an aspherical shape. For example, both surfaces of the fourth lens may be aspherical. The fourth lens may be made of a material having a high light transmittance and an excellent processability. For example, the fourth lens may be made of a glass or a plastic material. The fourth lens may have a predetermined refractive index. For example, the fourth lens may have a refractive index of 1.5 or more. The fourth lens may have a predetermined Abbe number. For example, the fourth lens may have an Abbe number of 50 or more.

The fifth lens may have a refractive power. For example, the fifth lens may have a negative refractive power. The fifth lens may have a concave shape on one surface. For example, the fifth lens may have a concave object-side surface. The fifth lens may have an aspherical shape. For example, both surfaces of the fifth lens may be aspherical. The fifth lens may be made of a material having a high light transmittance and an excellent processability. For example, the fifth lens may be made of a glass material. The fifth lens may have a predetermined refractive index. For example, the fifth lens may have a refractive index of 1.8 or more. The fifth lens may have a predetermined Abbe number. For example, the fifth lens may have an Abbe number of 20 or more.

The sixth lens may have a refractive power. For example, the sixth lens may have a negative refractive power. The sixth lens may have a concave shape on one surface. For example, the sixth lens may have a concave object-side surface. The sixth lens may have an aspherical shape. For example, both surfaces of the sixth lens may be aspherical. The sixth lens may be made of a material having a high light transmittance and an excellent processability. For example, the sixth lens may be made of a glass or a plastic material. The sixth lens may have a predetermined refractive index. For example, the sixth lens may have a refractive index of 1.6 or more. The sixth lens may have a predetermined Abbe number. For example, the sixth lens may have an Abbe number of 20 or more.

The seventh lens may have a refractive power. For example, the seventh lens may have a positive refractive power. The seventh lens may have a convex shape on one surface. For example, the seventh lens may have a convex image-side surface. The seventh lens may have an aspherical shape. For example, both surfaces of the seventh lens may be aspherical. The seventh lens may be made of a material having a high light transmittance and an excellent processability. For example, the seventh lens may be made of a glass or a plastic material. The seventh lens may have a predetermined refractive index. For example, the seventh lens may have a refractive index of 1.6 or more. The seventh lens may have a predetermined Abbe number. For example, the seventh lens may have an Abbe number of 15 or more.

The eighth lens may have a refractive power. For example, the eighth lens may have a negative refractive power. The eighth lens may have a concave shape on one surface. For example, the eighth lens may have a concave object-side surface. The eighth lens may have an aspherical shape. For example, both surfaces of the eighth lens may be aspherical. The eighth lens may have a shape having an inflection point. For example, an inflection point may be formed on either one or both of the object-side surface and the image-side surface of the eighth lens. The eighth lens may be made of a material having a high light transmittance and an excellent processability. For example, the eighth lens may be made of a glass or a plastic material. The eighth lens may have a predetermined refractive index. For example, the eighth lens may have a refractive index of 1.5 or more. The eighth lens may have a predetermined Abbe number. For example, the eighth lens may have an Abbe number of 50 or more.

An aspherical lens constituting an imaging lens system may be expressed by the following Equation 1.

$$Z = \frac{{cr}^{2}}{1 + \sqrt{1 - ( 1 + k ) {c}^{2} {r}^{2}}} + {Ar}^{4} + {Br}^{6} + {Cr}^{8} + {Dr}^{10} + {Er}^{12} + {Fr}^{14} + {Gr}^{16} + {Hr}^{18} + {Jr}^{20} \qquad ( 1 )$$

In Equation 1, c is a curvature of the lens surface and is equal to a reciprocal of a radius of curvature of the lens surface at an optical axis of the lens surface, k is a conic constant, and r is a distance from any point on the aspherical surface of the lens to the optical axis. In addition, constants A to H and J are aspherical surface coefficients. z (also known as sag) is a distance in a direction parallel to an optical axis direction between the point on the aspherical surface of the lens at the distance r from the optical axis of the aspherical surface to a tangential plane perpendicular to the optical axis and intersecting a vertex of the aspherical surface.

The imaging lens system may include an optical path conversion means, a stop, an imaging plane, and a filter.

The optical path conversion means may be disposed on one side of a lens. For example, the optical path conversion means may be disposed on an object side of the first lens. The optical path conversion means may be configured in a form including one or more reflective surfaces. For example, the optical path conversion means may be configured in a prism form. The stop may be disposed between two lenses. The imaging plane may be formed at a point where light refracted by the first lens to the eighth lens converges. The imaging plane may be formed by an image sensor. For example, the imaging plane may be formed on a surface of the image sensor or on an internal layer of the image sensor. The filter may be disposed between the eighth lens and the imaging plane. The filter may block certain wavelengths of light. For example, the filter may block light in infrared wavelengths.

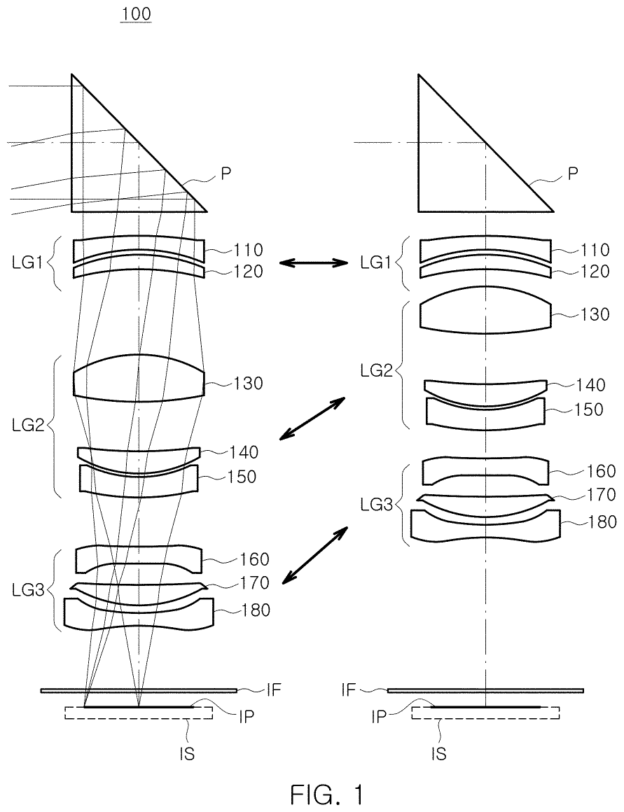

FIG. 1 is a configuration diagram of an imaging lens system according to a first embodiment of the present disclosure.

Referring to FIG. 1, an imaging lens system 100 may include a plurality of lens groups.

For example, the imaging lens system 100 may include a first lens group LG1, a second lens group LG2, and a third lens group LG3 sequentially arranged in ascending numerical order along an optical axis of the imaging lens system 100 from an object side of the imaging lens system 100 toward an imaging plane IP of the imaging lens system 100. Each lens group of LG1, LG2, and LG3 may be comprised of a plurality of lenses. For example, the first lens group LG1 may be comprised of a first lens 110 and a second lens 120, the second lens group LG2 may be comprised of a third lens 130, a fourth lens 140, and a fifth lens 150, and the third lens group LG3 may be comprised of a sixth lens 160, a seventh lens 170, and an eighth lens 180. However, the lenses constituting the first lens group LG1 to the third lens group LG3 may not limited to the above-described configurations.

The imaging lens system 100 may be configured to enable focus magnification adjustment (zoom in and zoom out) and focus adjustment (AF). For example, the second lens group LG2 and the third lens group LG3 may be configured to be driven in the optical axis direction. Furthermore, the second lens group LG2 may be driven to enable focus magnification adjustment of the imaging lens system 100, and the third lens group LG3 may be driven to enable focus adjustment of the imaging lens system 100.

The imaging lens system 100 may further include an optical path conversion means (P). The optical path conversion means (P) may be configured in a prism form and may be disposed on an object side of the first lens group LG1.

The optical characteristics of the lenses constituting the first lens group LG1 to the third lens group LG3 are described below.

The first lens 110 may have a negative refractive power, and may have a convex object-side surface and a concave image-side surface. The second lens 120 may have a positive refractive power, and may have a convex object-side surface and a concave image-side surface. The third lens 130 may have a positive refractive power, and a convex object-side surface and a convex image-side surface. The fourth lens 140 may have a positive refractive power, and may have a concave object-side surface and a convex image-side surface. The fifth lens 150 may have a negative refractive power, and may have a concave object-side surface and a convex image-side surface. The sixth lens 160 may have a negative refractive power, and may have a concave object-side surface and a concave image-side surface. The seventh lens 170 may have a positive refractive power, and may have a concave object-side surface and a convex image-side surface. The eighth lens 180 may have a negative refractive power and may have a concave object-side surface and a concave image-side surface.

The imaging lens system 100 may further include a filter (IF) and an imaging plane (IP). The imaging plane (IP) may be formed on the image sensor (IS), and the filter (IF) may be disposed between the eighth lens 180 and the imaging plane (IP).

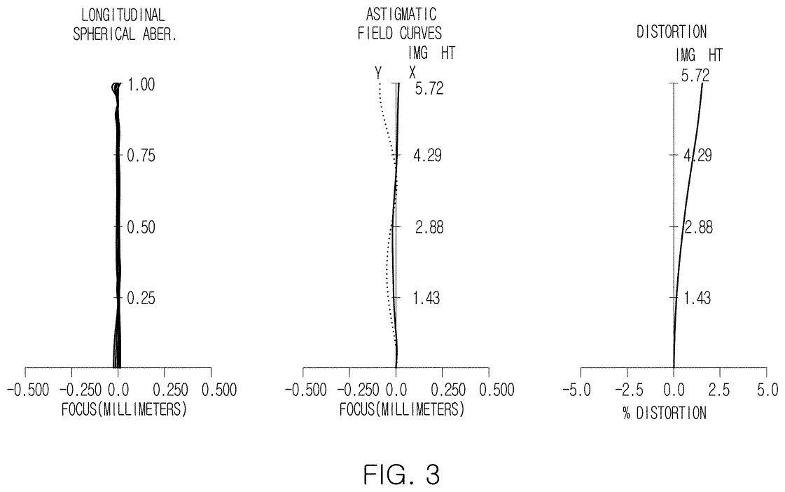

FIGS. 2 and 3 illustrate aberration curves of the imaging lens system according to the first embodiment.

Tables 1 and 2 below illustrate lens characteristics and aspheric values of the imaging lens system according to the first embodiment.

TABLE 1

| | | | Thickness/ | | | |
|---|---|---|---|---|---|---|
| | | | Distance | Thickness/ | | |
| | | | (Wide- | Distance | | |
| Surface | | Radius of | Angle | (Telephoto | Refractive | Abbe |
| No. | Component | Curvature | Mode) | Mode) | Index | No. |
| S1 | Prism | Infinity | 4.1500 | 4.1500 | 1.784 | 25.70 |
| S2 | | Infinity | 4.1500 | 4.1500 | 1.784 | 25.70 |
| S3 | | Infinity | 1.5000 | 1.5000 | | |
| S4 | 1st Lens | 14.8232 | 0.8600 | 0.8600 | 1.806 | 40.70 |
| S5 | | 8.0313 | 0.3058 | 0.3058 | | |
| S6 | 2nd Lens | 11.1727 | 0.8397 | 0.8397 | 1.671 | 19.20 |
| S7 | | 14.2099 | 5.2264 | 1.0400 | | |
| S8 | 3rd Lens | 7.4850 | 2.8770 | 2.8770 | 1.497 | 81.50 |
| S9 | | −16.6253 | 3.0944 | 3.0944 | | |
| S10 | 4th Lens | −37.1535 | 1.3423 | 1.3423 | 1.544 | 56.00 |
| S11 | | −7.3331 | 0.1800 | 0.1800 | | |
| S12 | 5th Lens | −5.7794 | 1.2000 | 1.2000 | 1.821 | 24.00 |
| S13 | | −9.5566 | 2.9808 | 1.7600 | | |
| S14 | 6th Lens | −15.6670 | 1.0381 | 1.0381 | 1.615 | 25.90 |
| S15 | | 129.0421 | 1.3393 | 1.3393 | | |
| S16 | 7th Lens | −95.0732 | 1.2000 | 1.2000 | 1.671 | 19.20 |
| S17 | | −10.8582 | 0.5000 | 0.5000 | | |
| S18 | 8th Lens | −2647.5074 | 0.7500 | 0.7500 | 1.544 | 56.00 |
| S19 | | 6.5000 | 3.8251 | 9.2266 | | |
| S20 | Filter | Infinity | 0.2100 | 0.2100 | 1.516 | 64.10 |
| S21 | | Infinity | 0.9300 | 0.9314 | | |
| S22 | Imaging | Infinity | 0.0011 | 0.0053 | | |
| | Plane | | | | | |

TABLE 2

Surface No.

| | S4 | S5 | S6 | S7 | S8 | S9 | S10 | S11 |
|---|---|---|---|---|---|---|---|---|
| k | −1.311E+01 | −1.813E+00 | −1.177E+00 | 2.686E+00 | −3.807E−01 | −9.900E+01 | 9.900E+01 | −4.934E+00 |
| A | −2.574E−01 | −2.909E−01 | 3.114E−03 | −6.672E−04 | 1.323E−02 | −1.350E−01 | 5.565E−02 | −1.269E−01 |
| B | 7.982E−03 | 6.867E−03 | 1.498E−02 | −1.453E−06 | 4.910E−03 | 4.331E−02 | −2.666E−03 | −3.008E−03 |
| C | 2.337E−03 | 4.798E−03 | 3.556E−03 | 6.302E−06 | 9.491E−04 | −8.835E−03 | 4.285E−03 | −6.311E−03 |
| D | −8.539E−04 | −2.565E−03 | −2.386E−03 | −9.420E−07 | 7.500E−04 | 3.694E−03 | 3.270E−03 | 4.040E−03 |
| E | 2.796E−04 | 1.014E−03 | 9.821E−04 | 9.407E−08 | 1.070E−04 | −8.950E−04 | 9.548E−04 | −1.679E−03 |
| F | −9.815E−05 | −3.473E−04 | −3.030E−04 | −6.087E−09 | 7.349E−05 | 3.780E−04 | 7.328E−04 | 7.291E−04 |
| G | 7.407E−05 | 2.658E−04 | 2.593E−04 | 2.403E−10 | −2.844E−06 | −1.137E−04 | 1.948E−04 | −3.424E−04 |
| H | −5.363E−05 | −2.554E−04 | −2.467E−04 | −5.264E−12 | 1.893E−05 | 5.049E−05 | 1.047E−04 | 1.089E−04 |
| J | 1.257E−05 | 9.319E−05 | 8.740E−05 | 4.941E−14 | −1.013E−05 | −2.086E−05 | 2.214E−05 | −1.640E−05 |

| | Surface No. | | | | | | | |
|---|---|---|---|---|---|---|---|---|
| | S12 | S13 | S14 | S15 | S16 | S17 | S18 | S19 |
| k | −9.668E+00 | −3.939E+01 | −9.900E+01 | −9.900E+01 | −9.900E+01 | 0.000E+00 | 9.900E+01 | −3.624E+00 |
| A | −1.380E−01 | −3.748E−03 | 3.391E−01 | 6.329E−01 | −1.299E−01 | −4.180E−03 | −1.091E+00 | −1.071E−02 |
| B | 2.776E−02 | 1.127E−03 | −2.123E−02 | −2.286E−02 | 2.048E−02 | 1.245E−03 | 1.455E−01 | 1.779E−03 |
| C | −9.499E−03 | −2.213E−04 | −3.204E−04 | 6.363E−03 | 1.681E−02 | −2.255E−04 | −3.614E−02 | −2.798E−04 |
| D | 4.079E−03 | 3.302E−05 | 7.115E−04 | 5.508E−04 | 9.992E−03 | 1.709E−05 | 1.159E−02 | 3.407E−05 |
| E | −1.301E−03 | −3.521E−06 | −6.848E−04 | −1.526E−03 | −1.314E−03 | 4.656E−07 | −1.689E−03 | −2.878E−06 |
| F | 5.476E−04 | 2.565E−07 | 7.128E−04 | 7.845E−05 | −3.791E−04 | −1.967E−07 | 1.621E−03 | 1.589E−07 |
| G | −2.656E−04 | −1.230E−08 | 1.199E−04 | 5.020E−05 | −3.726E−04 | 1.522E−08 | −9.297E−04 | −5.450E−09 |
| H | 8.160E−05 | 3.633E−10 | 1.031E−04 | 6.282E−05 | 4.183E−05 | −5.060E−10 | 2.315E−04 | 1.050E−10 |
| J | −1.210E−05 | −5.208E−12 | 1.193E−05 | 2.773E−05 | 6.789E−05 | 6.329E−12 | 1.253E−04 | −8.677E−13 |

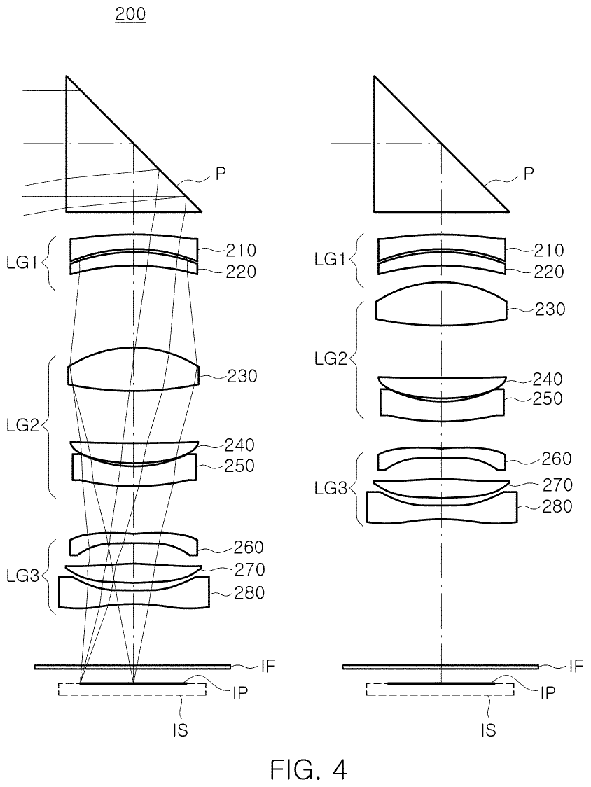

FIG. 4 is a configuration diagram of an imaging lens system according to a second embodiment of the present disclosure.

Referring to FIG. 4, an imaging lens system 200 may include a plurality of lens groups. For example, the imaging lens system 200 may include a first lens group LG1, a second lens group LG2, and a third lens group LG3 sequentially arranged in ascending numerical order along an optical axis of the imaging lens system 200 from an object side of the imaging lens system 200 toward an imaging plane IP of the imaging lens system 200. Each lens group of LG1, LG2, and LG3 may be comprised of a plurality of lenses. For example, the first lens group LG1 may be comprised of a first lens 210 and a second lens 220, the second lens group LG2 may be comprised of a third lens 230, a fourth lens 240, and a fifth lens 250, and the third lens group LG3 may be comprised of a sixth lens 260, a seventh lens 270, and an eighth lens 280. However, the lenses constituting the first lens group LG1 to the third lens group LG3 may not limited to the above-described forms.

The imaging lens system 200 may be configured to enable focus magnification adjustment (Zoom) and focus adjustment (AF). For example, the second lens group LG2 and the third lens group LG3 may be configured to be driven in an optical axis direction. Furthermore, the second lens group LG2 may be driven to enable focus magnification adjustment of the imaging lens system 200, and the third lens group LG3 may be driven to enable focus adjustment of the imaging lens system 200.

The imaging lens system 200 may further include an optical path conversion means (P). The optical path conversion means (P) may be configured in a prism form and may be disposed on an object side of the first lens group LG1.

The optical characteristics of the lenses constituting the first lens group LG1 to the third lens group LG3 are described below.

The first lens 210 may have a negative refractive power, and may have a convex object-side surface and a concave image-side surface. The second lens 220 may have a positive refractive power, and may have a convex object-side surface and a concave image-side surface. The third lens 230 may have a positive refractive power, and may have a convex object-side surface and a convex image-side surface. The fourth lens 240 may have a positive refractive power, and may have a concave object-side surface and a convex image-side surface. The fifth lens 250 may have a negative refractive power, and may have a concave object-side surface and a convex image-side surface. The sixth lens 260 may have a negative refractive power, and may have a concave object-side surface and a concave image-side surface. The seventh lens 270 may have a positive refractive power and may have a convex object-side surface and a convex image-side surface. The eighth lens 280 may have a negative refractive power and may have a convex object-side surface and a concave image-side surface.

The imaging lens system 200 may further include a filter (IF) and an imaging plane (IP). The imaging plane (IP) may be formed on an image sensor (IS), and the filter (IF) may be disposed between the eighth lens 280 and the imaging plane (IP).

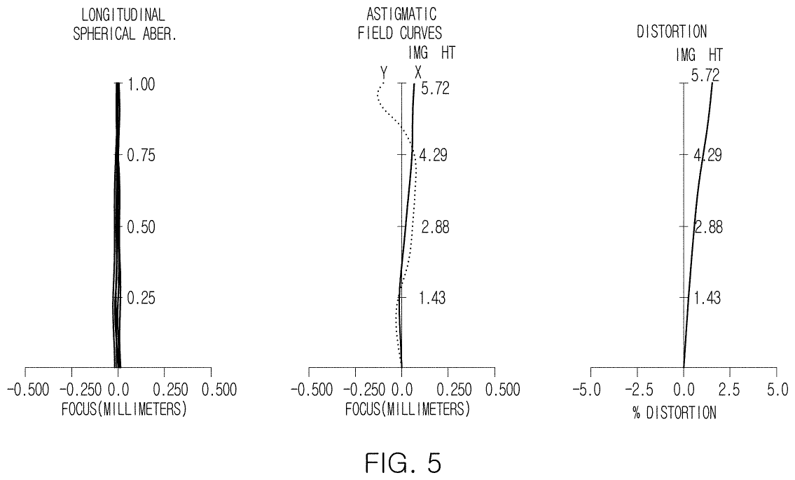

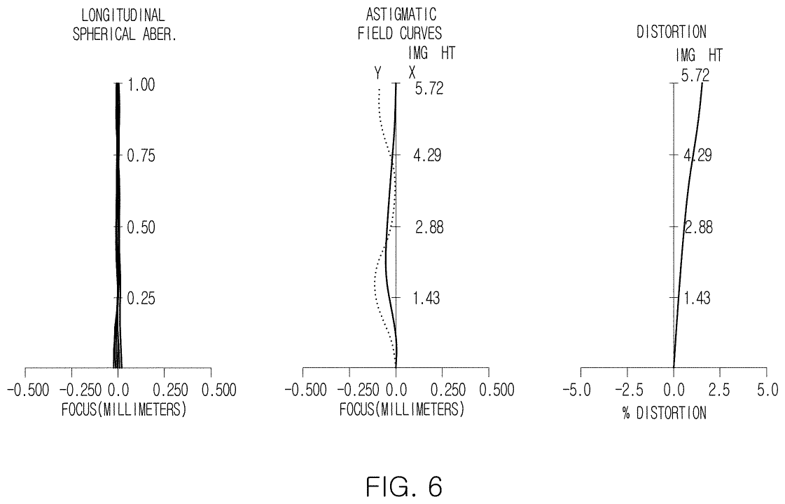

FIGS. 5 and 6 illustrate aberration curves of the imaging lens system according to the second embodiment.

Tables 3 and 4 below illustrate the lens characteristics and aspherical values of the imaging lens system according to the second embodiment.

TABLE 3

| | | | Thickness/ | Thickness/ | | |
|---|---|---|---|---|---|---|
| | | | Distance | Distance | | |
| Surface | | Radius of | (Wide-Angle | (Telephoto | Refractive | Abbe |
| No. | Component | Curvature | Mode) | Mode) | Index | No. |
| S1 | Prism | Infinity | 4.1500 | 4.1500 | 1.784 | 25.70 |
| S2 | | Infinity | 4.1500 | 4.1500 | 1.784 | 25.70 |
| S3 | | Infinity | 1.5000 | 1.5000 | | |
| S4 | 1st Lens | 20.2527 | 0.8600 | 0.8600 | 1.806 | 40.70 |
| S5 | | 9.1899 | 0.2209 | 0.2209 | | |
| S6 | 2nd Lens | 9.8866 | 0.8889 | 0.8889 | 1.671 | 19.20 |
| S7 | | 12.3137 | 5.1889 | 1.0400 | | |
| S8 | 3rd Lens | 7.2167 | 2.8025 | 2.8025 | 1.497 | 81.50 |
| S9 | | −17.9591 | 3.3463 | 3.3463 | | |
| S10 | 4th Lens | −38.6132 | 1.3201 | 1.3201 | 1.544 | 56.00 |
| S11 | | −7.5836 | 0.1800 | 0.1800 | | |
| S12 | 5th Lens | −6.1000 | 1.2000 | 1.2000 | 1.821 | 24.00 |
| S13 | | −10.9030 | 3.0661 | 1.7600 | | |
| S14 | 6th Lens | −24.5218 | 0.6200 | 0.6200 | 1.615 | 25.90 |
| S15 | | 24.5507 | 1.3368 | 1.3368 | | |
| S16 | 7th Lens | 14.4374 | 1.2000 | 1.2000 | 1.671 | 19.20 |
| S17 | | −85.1439 | 0.5000 | 0.5000 | | |
| S18 | 8th Lens | 42.4045 | 0.8281 | 0.8281 | 1.544 | 56.00 |
| S19 | | 6.6589 | 3.9951 | 9.4460 | | |
| S20 | Filter | Infinity | 0.2100 | 0.2100 | 1.516 | 64.10 |
| S21 | | Infinity | 0.9350 | 0.9350 | | |
| S22 | Imaging | Infinity | 0.0011 | 0.0053 | | |
| | Plane | | | | | |

TABLE 4

| | Surface No. | | | | | | | |
|---|---|---|---|---|---|---|---|---|
| | S4 | S5 | S6 | S7 | S8 | S9 | S10 | S11 |
| k | −1.348E+01 | −1.364E+00 | −3.193E+00 | −9.416E−02 | −3.748E−01 | −9.900E+01 | 9.900E+01 | −8.014E+00 |
| A | −2.365E−01 | −2.212E−01 | −9.617E−02 | −1.023E−03 | 1.593E−02 | −1.137E−01 | 2.140E−01 | −7.768E−02 |
| B | 1.367E−03 | −4.955E−03 | 1.150E−02 | −1.676E−06 | 7.266E−03 | 3.881E−02 | −5.841E−03 | 1.786E−02 |
| C | 4.863E−03 | 9.008E−03 | 1.762E−03 | 6.350E−06 | 1.132E−03 | −8.394E−03 | −1.829E−03 | −1.435E−02 |
| D | −1.259E−03 | −3.704E−03 | −3.930E−03 | −9.442E−07 | 5.318E−04 | 3.030E−03 | 5.849E−04 | 4.079E−03 |
| E | 4.648E−04 | 1.841E−03 | 1.994E−03 | 9.390E−08 | 4.631E−05 | −8.058E−04 | −2.492E−04 | −3.426E−03 |
| F | −3.478E−04 | −1.129E−03 | −9.335E−04 | −6.092E−09 | 8.071E−05 | 3.438E−04 | 3.681E−04 | 1.246E−03 |
| G | 1.761E−04 | 5.456E−04 | 4.877E−04 | 2.402E−10 | 4.313E−06 | −8.185E−05 | 8.799E−05 | −4.056E−04 |
| H | −4.979E−05 | −2.021E−04 | −2.008E−04 | −5.264E−12 | 2.205E−05 | 5.048E−05 | 5.527E−05 | 6.241E−05 |
| J | 1.247E−06 | 2.467E−05 | 3.967E−05 | 4.968E−14 | 6.398E−06 | −8.987E−06 | −4.757E−06 | −1.188E−04 |

| | Surface No. | | | | | | | |
|---|---|---|---|---|---|---|---|---|
| | S12 | S13 | S14 | S15 | S16 | S17 | S18 | S19 |
| k | −8.885E+00 | −5.604E+01 | −9.900E+01 | −9.900E+01 | −9.900E+01 | 0.000E+00 | 9.900E+01 | −1.140E+01 |
| A | −1.728E−01 | −4.365E−03 | 4.643E−01 | 6.021E−01 | −1.038E−01 | −6.941E−03 | −1.345E+00 | −8.568E−03 |
| B | 5.185E−02 | 1.176E−03 | −1.572E−02 | 5.290E−03 | −2.446E−02 | 1.428E−03 | 2.251E−01 | 1.757E−03 |
| C | −1.233E−02 | −2.225E−04 | −2.092E−03 | 8.779E−04 | 1.326E−02 | −2.239E−04 | −6.996E−02 | −2.839E−04 |
| D | 4.440E−03 | 3.296E−05 | −1.018E−03 | −9.953E−04 | 2.832E−03 | 1.650E−05 | 1.443E−02 | 3.414E−05 |
| E | −2.418E−03 | −3.510E−06 | −5.819E−04 | −9.096E−04 | 5.137E−04 | 4.732E−07 | −5.411E−03 | −2.868E−06 |
| F | 8.295E−04 | 2.573E−07 | −3.476E−04 | −6.563E−04 | −1.411E−03 | −1.952E−07 | 2.019E−03 | 1.595E−07 |
| G | −3.605E−04 | −1.235E−08 | 7.907E−05 | −1.332E−05 | −7.939E−04 | 1.521E−08 | −3.517E−04 | −5.521E−09 |
| H | 4.781E−05 | 3.549E−10 | 5.027E−05 | 9.841E−05 | −2.185E−04 | −5.126E−10 | 6.209E−04 | 1.065E−10 |
| J | −7.804E−05 | −4.748E−12 | 6.918E−05 | 1.345E−04 | 5.148E−05 | 6.426E−12 | 2.244E−04 | −8.604E−13 |

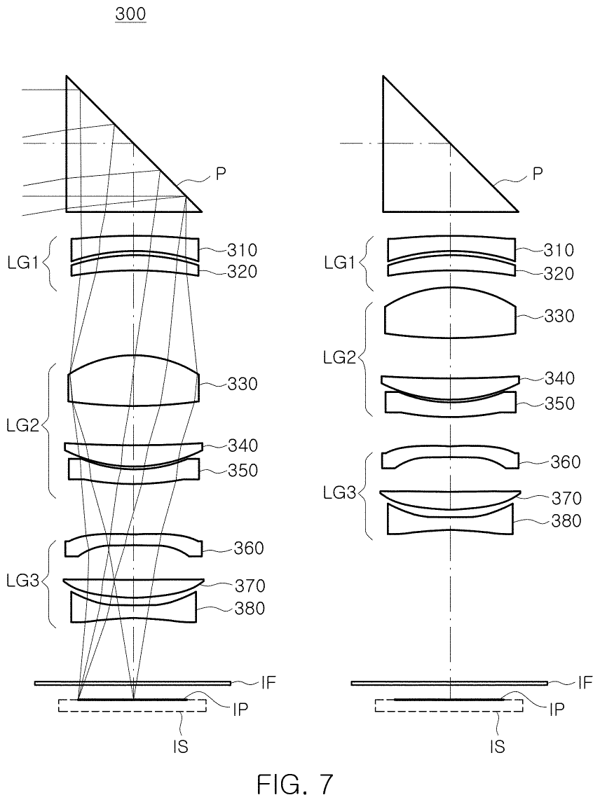

FIG. 7 is a configuration diagram of an imaging lens system according to a third embodiment of the present disclosure.

Referring to FIG. 7, an imaging lens system 300 may include a plurality of lens groups. For example, the imaging lens system 300 may include a first lens group LG1, a second lens group LG2, and a third lens group LG3 sequentially arranged in ascending numerical order along an optical axis of the imaging lens system 300 from an object side of the imaging lens system 300 toward an imaging plane IP of the imaging lens system 300. Each of the lens groups of LG1, LG2, and LG3 may be comprised of a plurality of lenses. For example, the first lens group LG1 may be comprised of a first lens 310 and a second lens 320, the second lens group LG2 may be comprised of a third lens 330, a fourth lens 340, and a fifth lens 350, and the third lens group LG3 may be comprised of a sixth lens 360, a seventh lens 370, and an eighth lens 380. However, the lenses constituting the first lens group LG1 to the third lens group LG3 may not limited to the above-described forms.

The imaging lens system 300 may be configured to enable focus magnification adjustment (Zoom) and focus adjustment (AF). For example, the second lens group LG2 and the third lens group LG3 may be configured to be driven in the optical axis direction. Furthermore, the second lens group LG2 may be driven to enable focus magnification adjustment of the imaging lens system 300, and the third lens group LG3 may be driven to enable focus adjustment of the imaging lens system 300.

The imaging lens system 300 may further include an optical path conversion means (P). The optical path conversion means (P) may be configured in a prism form and may be disposed on an object side of the first lens group LG1.

The optical characteristics of the lenses constituting the first lens group LG1 to the third lens group LG3 are described below.

The first lens 310 may have a negative refractive power, and may have a convex object-side surface and a concave image-side surface. The second lens 320 may have a positive refractive power, and may have a convex object-side surface and a concave image-side surface. The third lens 330 may have a positive refractive power, and may have a convex object-side surface and a convex image-side surface. The fourth lens 340 may have a positive refractive power, and may have a concave object-side surface and a convex image-side surface. The fifth lens 350 may have a negative refractive power, and may have a concave object-side surface and a convex image-side surface. The sixth lens 360 may have a negative refractive power, and may have a concave object-side surface and a concave image-side surface. The seventh lens 370 may have a positive refractive power, and may have a concave object-side surface and a convex image-side surface. The eighth lens 380 may have a negative refractive power and may have a concave object-side surface and a concave image-side surface.

The imaging lens system 300 may further include a filter (IF) and an imaging plane (IP). The imaging plane (IP) may be formed on an image sensor (IS), and the filter (IF) may be disposed between the eighth lens 380 and the imaging plane (IP).

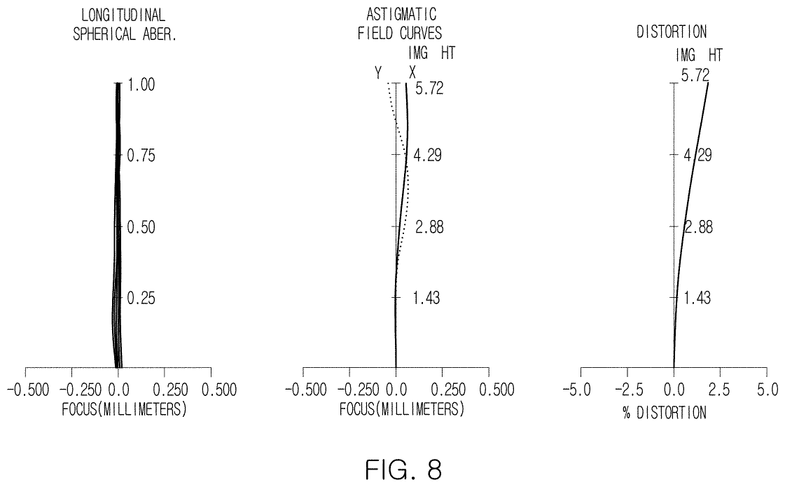

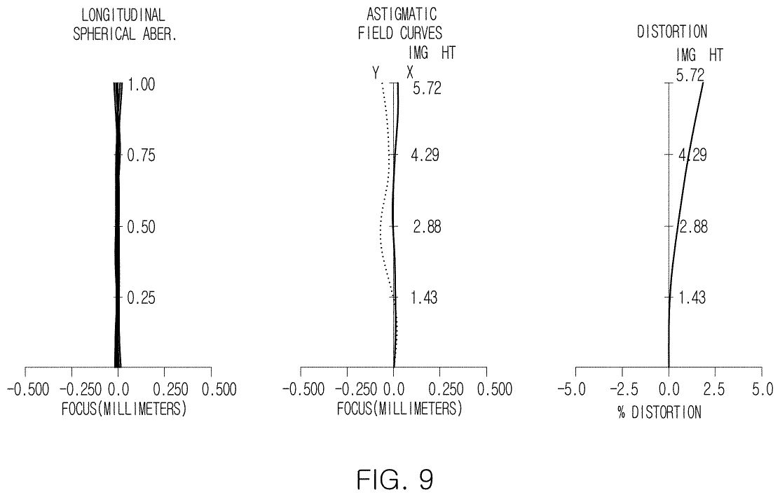

FIGS. 8 and 9 illustrate aberration curves of the imaging lens system according to the third embodiment.

Tables 5 and 6 below illustrate the lens characteristics and aspherical values of the imaging lens system according to the third embodiment.

TABLE 5

| | | | Thickness/ | Thickness/ | | |
|---|---|---|---|---|---|---|
| | | | Distance | Distance | | |
| Surface | | Radius of | (Wide-Angle | (Telephoto | Refractive | Abbe |
| No. | Component | Curvature | Mode) | Mode) | Index | No. |
| S1 | Prism | Infinity | 4.1500 | 4.1500 | 1.784 | 25.70 |
| S2 | | Infinity | 4.1500 | 4.1500 | 1.784 | 25.70 |
| S3 | | Infinity | 1.5000 | 1.5000 | | |
| S4 | 1st Lens | 46.8376 | 0.8600 | 0.8600 | 1.806 | 40.70 |
| S5 | | 13.0342 | 0.3049 | 0.3049 | | |
| S6 | 2nd Lens | 10.8882 | 0.9164 | 0.9164 | 1.671 | 19.20 |
| S7 | | 13.7565 | 5.2406 | 1.0400 | | |
| S8 | 3rd Lens | 7.0100 | 3.0750 | 3.0750 | 1.497 | 81.50 |
| S9 | | −19.0493 | 2.4582 | 2.4582 | | |
| S10 | 4th Lens | −41.6191 | 1.2481 | 1.2481 | 1.544 | 56.00 |
| S11 | | −8.7298 | 0.1800 | 0.1800 | | |
| S12 | 5th Lens | −6.0928 | 0.9200 | 0.9200 | 1.821 | 24.00 |
| S13 | | −9.6810 | 3.1057 | 1.8698 | | |
| S14 | 6th Lens | −25.4089 | 0.6200 | 0.6200 | 1.615 | 25.90 |
| S15 | | 59.0207 | 2.1470 | 2.1470 | | |
| S16 | 7th Lens | −1943.8925 | 1.1040 | 1.1040 | 1.671 | 19.20 |
| S17 | | −13.5123 | 0.5000 | 0.5000 | | |
| S18 | 8th Lens | −41.7411 | 0.7500 | 0.7500 | 1.544 | 56.00 |
| S19 | | 7.5919 | 3.9307 | 9.3590 | | |
| S20 | Filter | Infinity | 0.2100 | 0.2100 | 1.516 | 64.10 |
| S21 | | Infinity | 0.9300 | 0.9324 | | |
| S22 | Imaging | Infinity | −0.0006 | 0.0053 | | |
| | Plane | | | | | |

TABLE 6

| Surface No. | S4 | S5 | S6 | S7 | S8 | S9 | S10 | S11 |
|---|---|---|---|---|---|---|---|---|
| k | 2.813E+01 | 5.248E−01 | −3.622E+00 | 1.039E+00 | −3.595E−01 | −9.900E+01 | 9.900E+01 | −7.042E+00 |
| A | −2.114E−01 | −8.421E−02 | −1.767E−01 | −7.938E−04 | 3.240E−02 | −3.832E−02 | 1.130E−01 | −1.885E−01 |
| B | −6.617E−04 | 8.655E−03 | −1.679E−02 | −2.211E−05 | −3.090E−03 | 1.764E−02 | −7.795E−03 | −1.468E−02 |
| C | 1.706E−03 | 1.821E−02 | −1.749E−03 | 6.236E−06 | −4.830E−03 | −7.538E−03 | 1.332E−02 | 4.446E−03 |
| D | −6.311E−03 | 3.351E−03 | −3.534E−03 | −9.420E−07 | −1.097E−03 | 1.695E−03 | 5.146E−03 | 6.650E−03 |
| E | −2.014E−03 | 6.661E−03 | 1.125E−03 | 9.401E−08 | −5.476E−04 | −6.371E−04 | 1.090E−03 | −5.172E−03 |
| F | −1.880E−03 | 1.768E−03 | −7.715E−04 | −6.087E−09 | −6.065E−05 | 1.866E−04 | 1.134E−03 | −1.791E−04 |
| G | −4.683E−04 | 1.846E−03 | 5.952E−04 | 2.404E−10 | −4.077E−05 | −6.459E−05 | 4.562E−05 | −2.517E−03 |
| H | −4.987E−04 | −3.894E−04 | −9.800E−05 | −5.262E−12 | 1.773E−06 | 1.728E−05 | 7.023E−05 | −4.455E−05 |
| J | 1.438E−04 | 2.164E−04 | 6.031E−05 | 4.888E−14 | 4.670E−06 | −1.870E−06 | −2.356E−05 | −4.840E−04 |

| Surface No. | S12 | S13 | S14 | S15 | S16 | S17 | S18 | S19 |
|---|---|---|---|---|---|---|---|---|
| k | −1.162E+01 | −4.884E+01 | −9.900E+01 | −9.900E+01 | −9.900E+01 | 0.000E+00 | 9.900E+01 | −3.301E+01 |
| A | −8.257E−02 | 5.069E−02 | 4.112E−01 | 6.109E−01 | −9.730E−02 | −1.936E−03 | −9.100E−01 | −2.531E−03 |
| B | 1.174E−02 | 3.743E−02 | −3.198E−02 | −3.320E−02 | −2.447E−02 | 1.034E−03 | 3.302E−01 | 4.817E−04 |
| C | −2.381E−02 | −1.626E−02 | 6.356E−03 | 1.022E−02 | 2.299E−02 | −2.224E−04 | 4.066E−03 | −1.027E−04 |
| D | 6.210E−03 | 4.734E−03 | −7.086E−04 | −1.080E−03 | −1.122E−02 | 1.752E−05 | 6.315E−02 | 1.663E−05 |
| E | −4.862E−03 | −1.456E−03 | −3.528E−04 | −7.751E−04 | −7.923E−03 | 4.807E−07 | 1.812E−02 | −1.727E−06 |
| F | −5.903E−05 | 4.393E−04 | 8.743E−05 | 1.116E−04 | 7.395E−04 | −1.975E−07 | 1.811E−02 | 1.109E−07 |
| G | −1.476E−03 | −2.209E−04 | −1.621E−06 | −7.377E−06 | 1.532E−03 | 1.512E−08 | 7.012E−03 | −4.299E−09 |
| H | 5.243E−05 | 5.653E−05 | −2.507E−07 | 5.728E−07 | 1.247E−03 | −5.033E−10 | 4.902E−03 | 9.244E−11 |
| J | −2.326E−04 | −2.454E−05 | −1.134E−06 | −2.176E−06 | 3.872E−04 | 6.250E−12 | 2.346E−04 | −8.494E−13 |

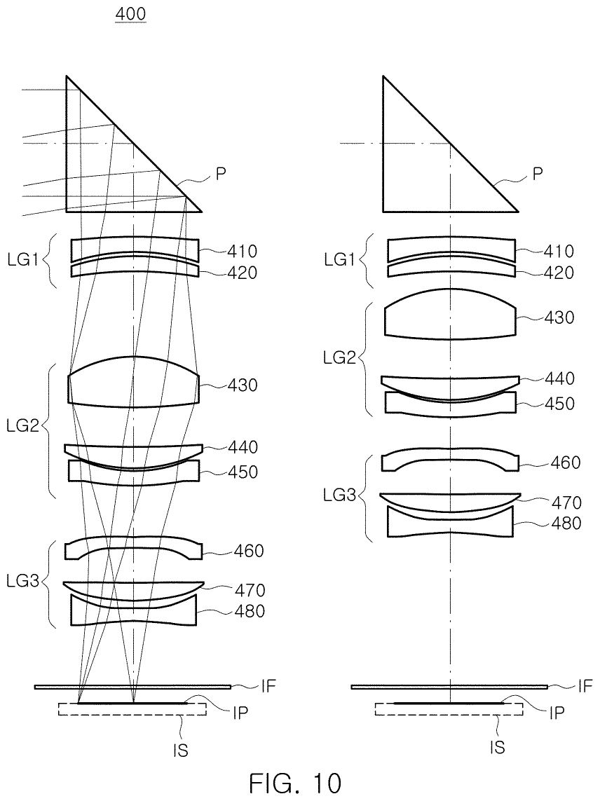

FIG. 10 is a configuration diagram of an imaging lens system according to a fourth embodiment of the present disclosure.

Referring to FIG. 10, an imaging lens system 400 may include a plurality of lens groups. For example, the imaging lens system 400 may include a first lens group LG1, a second lens group LG2, and a third lens group LG3 sequentially arranged in ascending numerical order along an optical axis of the imaging lens system 400 from an object side of the imaging lens system 400 toward an imaging plane IP of the imaging lens system 400. Each of the lens groups of LG1, LG2, and LG3 may be comprised of a plurality of lenses. For example, the first lens group LG1 may be comprised of a first lens 410 and a second lens 420, the second lens group LG2 may be comprised of a third lens 430, a fourth lens 440, and a fifth lens 450, and the third lens group LG3 may be comprised of a sixth lens 460, a seventh lens 470, and an eighth lens 480. However, the lenses constituting the first lens group LG1 to the third lens group LG3 are not limited to the above-described forms.

The imaging lens system 400 may be configured to enable focus magnification adjustment (Zoom) and focus adjustment (AF). For example, the second lens group LG2 and the third lens group LG3 may be configured to be driven in the optical axis direction. Furthermore, the second lens group LG2 may be driven to enable focus magnification adjustment of the imaging lens system 400, and the third lens group LG3 may be driven to enable focus adjustment of the imaging lens system 400.

The imaging lens system 400 may further include an optical path conversion means (P). The optical path conversion means (P) may be configured in a prism form and may be disposed on an object side of the first lens group LG1.

The optical characteristics of the lenses constituting the first lens group LG1 to the third lens group LG3 are described below.

The first lens 410 may have a negative refractive power, and may have a convex object-side surface and a concave image-side surface. The second lens 420 may have a positive refractive power, and may have a convex object-side surface and a concave image-side surface. The third lens 430 may have a positive refractive power, and may have a convex object-side surface and a convex image-side surface. The fourth lens 440 may have a positive refractive power, and may have a concave object-side surface and a convex image-side surface. The fifth lens 450 may have a negative refractive power, and may have a concave object-side surface and a convex image-side surface. The sixth lens 460 may have a negative refractive power, and may have a concave object-side surface and a concave image-side surface. The seventh lens 470 may have a positive refractive power, and may have a convex object-side surface and a convex image-side surface. The eighth lens 480 may have a negative refractive power and may have a concave object-side surface and a concave image-side surface.

The imaging lens system 400 may further include a filter (IF) and an imaging plane (IP). The imaging plane (IP) may be formed on an image sensor (IS), and the filter (IF) may be disposed between the eighth lens 480 and the imaging plane (IP).

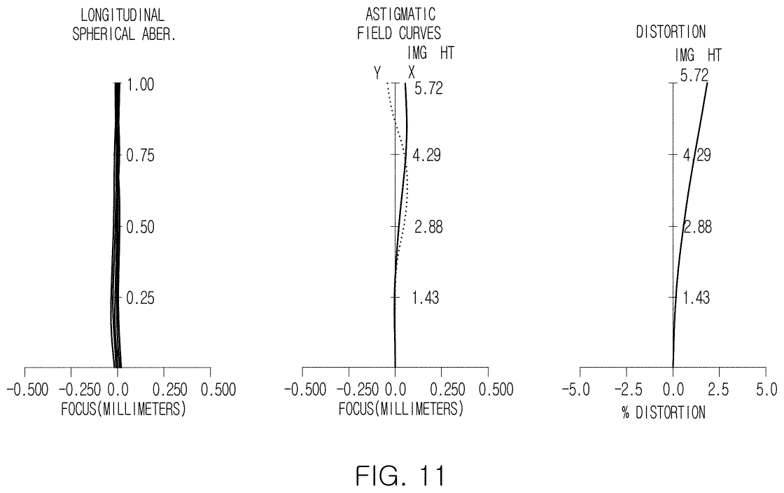

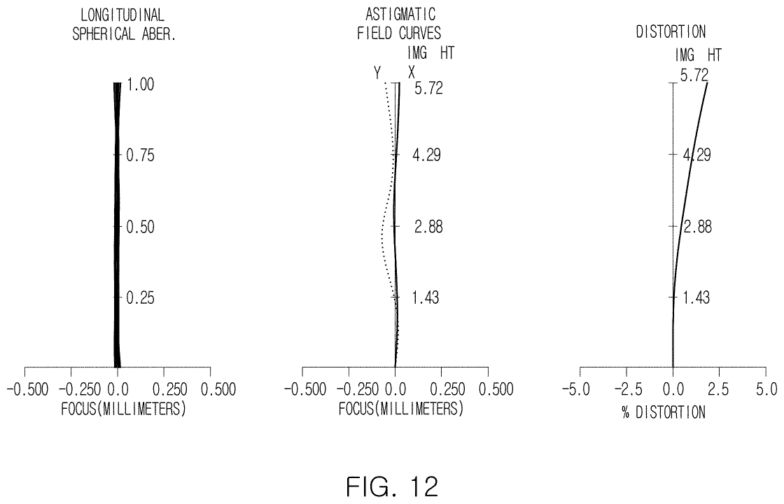

FIGS. 11 and 12 illustrate aberration curves of the imaging lens system according to the fourth embodiment.

Tables 7 and 8 below illustrate the lens characteristics and aspherical values of the imaging lens system according to the fourth embodiment.

TABLE 7

| | | | Thickness/ | Thickness/ | | |
|---|---|---|---|---|---|---|
| | | | Distance | Distance | | |
| Surface | | Radius of | (Wide-Angle | (Telephoto | Refractive | Abbe |
| No. | Component | Curvature | Mode) | Mode) | Index | No. |
| S1 | Prism | Infinity | 4.1500 | 4.1500 | 1.784 | 25.70 |
| S2 | | Infinity | 4.1500 | 4.1500 | 1.784 | 25.70 |
| S3 | | Infinity | 1.5000 | 1.5000 | | |
| S4 | 1st Lens | 45.9276 | 0.8600 | 0.8600 | 1.806 | 40.70 |
| S5 | | 13.1474 | 0.3607 | 0.3607 | | |
| S6 | 2nd Lens | 10.9304 | 0.8982 | 0.8982 | 1.671 | 19.20 |
| S7 | | 13.7170 | 5.2452 | 1.0400 | | |
| S8 | 3rd Lens | 7.0100 | 3.0896 | 3.0896 | 1.497 | 81.50 |
| S9 | | −19.1521 | 2.5569 | 2.5569 | | |
| S10 | 4th Lens | −42.5946 | 1.2639 | 1.2639 | 1.544 | 56.00 |
| S11 | | −8.5435 | 0.1846 | 0.1846 | | |
| S12 | 5th Lens | −5.9293 | 0.9200 | 0.9200 | 1.821 | 24.00 |
| S13 | | −9.5297 | 3.1185 | 1.8335 | | |
| S14 | 6th Lens | −23.9311 | 0.6200 | 0.6200 | 1.615 | 25.90 |
| S15 | | 55.5297 | 1.9717 | 1.9717 | | |
| S16 | 7th Lens | 189.8452 | 1.1173 | 1.1173 | 1.671 | 19.20 |
| S17 | | −13.9092 | 0.5000 | 0.5000 | | |
| S18 | 8th Lens | −41.5690 | 0.7500 | 0.7500 | 1.544 | 56.00 |
| S19 | | 7.5237 | 3.9018 | 9.3886 | | |
| S20 | Filter | Infinity | 0.2100 | 0.2100 | 1.516 | 64.10 |
| S21 | | Infinity | 0.9300 | 0.9299 | | |
| S22 | Imaging | Infinity | 0.0016 | 0.0053 | | |
| | Plane | | | | | |

TABLE 8

| Surface No. | S4 | S5 | S6 | S7 | S8 | S9 | S10 | S11 |
|---|---|---|---|---|---|---|---|---|
| k | 2.878E+01 | 4.406E−01 | −3.879E+00 | 9.963E−01 | −3.596E−01 | −9.900E+01 | 9.900E+01 | −7.401E+00 |
| A | −2.104E−01 | −8.957E−02 | −1.833E−01 | −7.953E−04 | 3.197E−02 | −4.452E−02 | 1.088E−01 | −1.812E−01 |
| B | 2.062E−03 | 1.277E−02 | −1.412E−02 | −2.240E−05 | −2.206E−03 | 1.850E−02 | −6.009E−03 | −1.712E−02 |
| C | 1.280E−03 | 1.528E−02 | −2.908E−03 | 6.233E−06 | −3.793E−03 | −7.255E−03 | 1.251E−02 | 6.506E−03 |
| D | −5.598E−03 | 4.231E−03 | −2.638E−03 | −9.418E−07 | −9.097E−04 | 1.666E−03 | 2.900E−03 | 3.789E−03 |
| E | −2.419E−03 | 5.705E−03 | 4.862E−04 | 9.403E−08 | −4.813E−04 | −6.333E−04 | 6.006E−04 | −3.536E−03 |
| F | −1.584E−03 | 2.735E−03 | −5.774E−04 | −6.086E−09 | −6.841E−05 | 1.781E−04 | 7.818E−04 | 1.007E−04 |
| G | −5.982E−04 | 2.042E−03 | 3.247E−04 | 2.404E−10 | −4.020E−05 | −6.303E−05 | 1.220E−05 | −1.711E−03 |
| H | −4.470E−04 | 1.447E−04 | −5.177E−05 | −5.263E−12 | −2.017E−06 | 1.679E−05 | 2.025E−05 | 2.836E−05 |
| J | 2.798E−05 | 2.033E−04 | 5.939E−05 | 4.883E−14 | 1.946E−06 | −1.904E−06 | −2.323E−05 | −2.343E−04 |

| Surface No. | S12 | S13 | S14 | S15 | S16 | S17 | S18 | S19 |
|---|---|---|---|---|---|---|---|---|
| k | −1.141E+01 | −4.842E+01 | −9.900E+01 | −9.900E+01 | −9.900E+01 | 0.000E+00 | 9.900E+01 | −3.301E+01 |
| A | −8.913E−02 | 4.559E−02 | 4.044E−01 | 6.025E−01 | −1.164E−01 | −1.951E−03 | −9.900E−01 | −2.619E−03 |
| B | 9.823E−03 | 3.771E−02 | −3.096E−02 | −3.266E−02 | −1.438E−02 | 1.028E−03 | 3.038E−01 | 4.736E−04 |
| C | −2.083E−02 | −1.629E−02 | 6.533E−03 | 1.070E−02 | 2.393E−02 | −2.224E−04 | 3.765E−03 | −1.025E−04 |
| D | 6.251E−03 | 5.132E−03 | −8.745E−04 | −1.294E−03 | −1.216E−02 | 1.753E−05 | 6.125E−02 | 1.665E−05 |
| E | −3.626E−03 | −1.600E−03 | −3.509E−04 | −7.796E−04 | −8.259E−03 | 4.813E−07 | 2.055E−02 | −1.727E−06 |
| F | 3.861E−04 | 4.723E−04 | 8.866E−05 | 1.216E−04 | 5.526E−04 | −1.975E−07 | 1.991E−02 | 1.109E−07 |
| G | 9.337E−04 | −2.141E−04 | −6.348E−07 | −3.367E−06 | 1.415E−03 | 1.512E−08 | 7.881E−03 | −4.299E−09 |
| H | 8.163E−05 | 5.868E−05 | −5.734E−07 | 6.567E−06 | 1.183E−03 | −5.034E−10 | 5.180E−03 | 9.242E−11 |
| J | −1.057E−04 | −1.811E−05 | −6.426E−07 | −1.966E−06 | 3.842E−04 | 6.245E−12 | 4.643E−04 | −8.478E−13 |

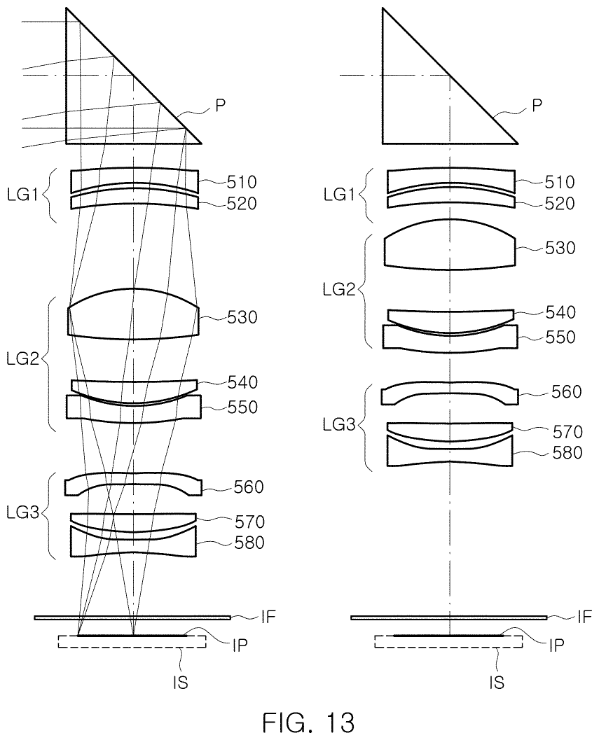

FIG. 13 is a configuration diagram of an imaging lens system according to a fifth embodiment of the present disclosure.

Referring to FIG. 13, an imaging lens system 500 may include a plurality of lens groups. For example, the imaging lens system 500 may include a first lens group LG1, a second lens group LG2, and a third lens group LG3 disposed sequentially arranged in ascending numerical order along an optical axis of the imaging lens system 500 from an object side of the imaging lens system 500 toward an imaging plane IP of the imaging lens system 500. Each lens group of LG1, LG2, and LG3 may be comprised of a plurality of lenses. For example, the first lens group LG1 may be comprised of a first lens 510 and a second lens 520, the second lens group LG2 may be comprised of a third lens 530, a fourth lens 540, and a fifth lens 550, and the third lens group LG3 may be comprised of a sixth lens 560, a seventh lens 570, and an eighth lens 580. However, the lenses constituting the first lens group LG1 to the third lens group LG3 may not limited to the above-described forms.

The imaging lens system 500 may be configured to enable focus magnification adjustment (Zoom) and focus adjustment (AF). For example, the second lens group LG2 and the third lens group LG3 may be configured to be driven in the optical axis direction. Furthermore, the second lens group LG2 may be driven to enable focus adjustment of the imaging lens system 500, and the third lens group LG3 may be driven to enable focus adjustment of the imaging lens system 500.

The imaging lens system 500 may further include an optical path conversion means (P). The optical path conversion means (P) may be configured in a prism form and may be disposed on an object side of the first lens group LG1.

The optical characteristics of the lenses constituting the first lens group LG1 to the third lens group LG3 are described below.

The first lens 510 may have a negative refractive power, and may have a convex object-side surface and a concave image-side surface. The second lens 520 may have a positive refractive power, and may have a convex object-side surface and a concave image-side surface. The third lens 530 may have a positive refractive power, and may have a convex object-side surface and a convex image-side surface. The fourth lens 540 may have a positive refractive power, and may have a concave object-side surface and a convex image-side surface. The fifth lens 550 may have a negative refractive power, and may have a concave object-side surface and a convex image-side surface. The sixth lens 560 may have a negative refractive power, and may have a concave object-side surface and a convex image-side surface. The seventh lens 570 may have a positive refractive power, and may have a convex object-side surface and a convex image-side surface. The eighth lens 580 may have a negative refractive power and may have a concave object-side surface and a concave image-side surface.

The imaging lens system 500 may further include a filter (IF) and an imaging plane (IP). The imaging plane (IP) may be formed on an image sensor (IS), and the filter (IF) may be disposed between the eighth lens 580 and the imaging plane (IP).

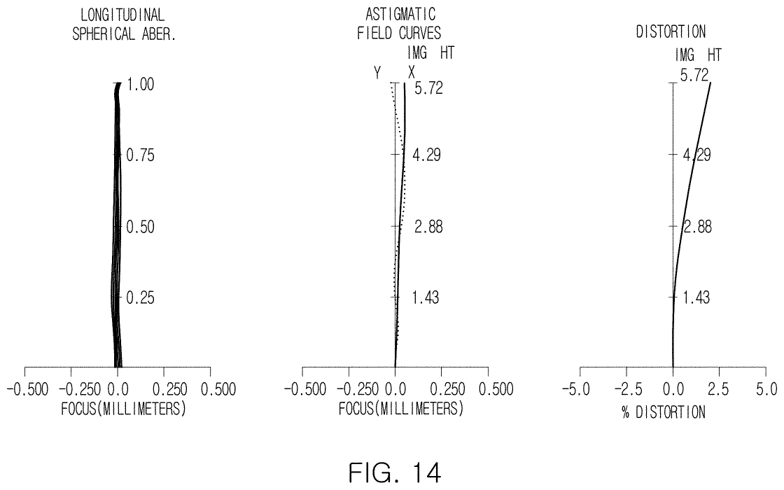

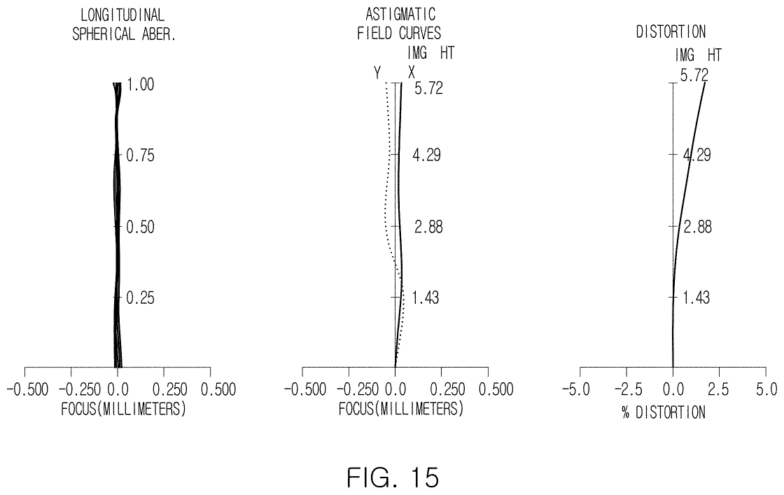

FIGS. 14 and 15 below illustrate aberration curves of the imaging lens system according to the fifth embodiment.

Tables 9 and 10 below illustrate the lens characteristics and aspherical values of the imaging lens system according to the fifth embodiment.

TABLE 9

| | | | Thickness/ | Thickness/ | | |
|---|---|---|---|---|---|---|
| | | | Distance | Distance | | |
| Surface | | Radius of | (Wide-Angle | (Telephoto | Refractive | Abbe |
| No. | Component | Curvature | Mode) | Mode) | Index | No. |
| S1 | Prism | Infinity | 4.1500 | 4.1500 | 1.784 | 25.70 |
| S2 | | Infinity | 4.1500 | 4.1500 | 1.784 | 25.70 |
| S3 | | Infinity | 1.5000 | 1.5000 | | |
| S4 | 1st Lens | 39.9414 | 0.8600 | 0.8600 | 1.806 | 40.70 |
| S5 | | 12.7402 | 0.3439 | 0.3439 | | |
| S6 | 2nd Lens | 11.0023 | 0.8999 | 0.8999 | 1.671 | 19.20 |
| S7 | | 13.7530 | 5.2496 | 1.0400 | | |
| S8 | 3rd Lens | 7.0100 | 3.0964 | 3.0964 | 1.497 | 81.50 |
| S9 | | −19.2798 | 2.5950 | 2.5950 | | |
| S10 | 4th Lens | −42.3577 | 1.2967 | 1.2967 | 1.544 | 56.00 |
| S11 | | −8.2191 | 0.1800 | 0.1800 | | |
| S12 | 5th Lens | −5.7762 | 1.0179 | 1.0179 | 1.821 | 24.00 |
| S13 | | −9.2878 | 3.1096 | 1.8220 | | |
| S14 | 6th Lens | −15.1259 | 0.6200 | 0.6200 | 1.615 | 25.90 |
| S15 | | −167.3383 | 1.8134 | 1.8134 | | |
| S16 | 7th Lens | 382.9335 | 1.1016 | 1.1016 | 1.671 | 19.20 |
| S17 | | −13.4608 | 0.5000 | 0.5000 | | |
| S18 | 8th Lens | −41.3810 | 0.7500 | 0.7500 | 1.544 | 56.00 |
| S19 | | 7.4033 | 3.9214 | 9.4098 | | |
| S20 | Filter | Infinity | 0.2100 | 0.2100 | 1.516 | 64.10 |
| S21 | | Infinity | 0.9300 | 0.9381 | | |
| S22 | Imaging | Infinity | 0.0046 | 0.0053 | | |
| | Plane | | | | | |

TABLE 10

| Surface No. | S4 | S5 | S6 | S7 | S8 | S9 | S10 | S11 |
|---|---|---|---|---|---|---|---|---|
| k | 2.272E+01 | −1.869E−02 | −3.875E+00 | 1.152E+00 | −3.456E−01 | −9.900E+01 | 9.900E+01 | −7.821E+00 |
| A | −2.389E−01 | −1.197E−01 | −1.840E−01 | −7.862E−04 | 3.620E−02 | −4.535E−02 | 8.489E−02 | −1.792E−01 |
| B | 6.736E−03 | 1.674E−02 | −1.318E−02 | −2.220E−05 | −5.443E−04 | 1.905E−02 | −1.521E−02 | −3.197E−02 |
| C | 2.551E−03 | 1.367E−02 | −1.743E−03 | 6.186E−06 | −2.959E−03 | −7.416E−03 | 1.443E−02 | 9.033E−03 |
| D | −2.257E−03 | 4.190E−03 | −1.604E−03 | −9.420E−07 | −9.384E−04 | 1.591E−03 | 2.542E−03 | −3.439E−04 |
| E | −9.702E−04 | 4.820E−03 | 3.007E−04 | 9.407E−08 | −5.113E−04 | −7.222E−04 | 7.845E−04 | −2.886E−03 |
| F | −3.687E−04 | 3.291E−03 | −4.309E−04 | −6.084E−09 | −1.109E−04 | 1.828E−04 | 9.438E−04 | 6.429E−05 |
| G | −1.753E−04 | 2.218E−03 | 7.993E−05 | 2.404E−10 | −4.832E−05 | −7.119E−05 | 1.480E−04 | −1.522E−03 |
| H | −1.733E−04 | 6.311E−04 | 3.017E−05 | −5.264E−12 | −1.405E−05 | 1.903E−05 | 7.530E−05 | −2.864E−04 |
| J | −9.148E−05 | 6.936E−05 | 4.928E−05 | 4.887E−14 | −5.400E−06 | −2.921E−06 | −1.510E−05 | −2.976E−04 |

| Surface No. | S12 | S13 | S14 | S15 | S16 | S17 | S18 | S19 |
|---|---|---|---|---|---|---|---|---|
| k | −1.091E+01 | −4.341E+01 | −9.900E+01 | −9.900E+01 | −9.900E+01 | 0.000E+00 | 9.900E+01 | −3.301E+01 |
| A | −9.731E−02 | 1.788E−02 | 4.046E−01 | 6.410E−01 | −1.202E−01 | −1.803E−03 | −9.579E−01 | −2.450E−03 |
| B | 2.086E−02 | 4.576E−02 | −2.622E−02 | −4.078E−02 | −4.738E−03 | 9.967E−04 | 3.186E−01 | 4.307E−04 |
| C | −1.813E−02 | −1.639E−02 | 4.698E−03 | 1.124E−02 | 2.794E−02 | −2.212E−04 | 7.307E−03 | −9.997E−05 |
| D | 5.520E−03 | 5.084E−03 | −2.068E−04 | −7.111E−04 | −1.300E−02 | 1.754E−05 | 6.099E−02 | 1.666E−05 |
| E | −3.051E−03 | −1.433E−03 | −4.625E−04 | −4.130E−04 | −1.034E−02 | 4.798E−07 | 2.204E−02 | −1.730E−06 |
| F | 3.514E−04 | 4.028E−04 | 8.518E−05 | −2.800E−05 | −1.145E−04 | −1.974E−07 | 1.869E−02 | 1.108E−07 |
| G | −7.737E−04 | −1.804E−04 | −1.565E−05 | −1.540E−05 | 1.883E−03 | 1.514E−08 | 5.266E−03 | −4.296E−09 |
| H | −4.551E−05 | 5.443E−05 | 6.810E−06 | 4.524E−06 | 1.475E−03 | −5.027E−10 | 3.785E−03 | 9.273E−11 |
| J | −1.601E−04 | −2.052E−05 | −1.806E−06 | 6.826E−07 | 4.648E−04 | 6.158E−12 | 4.090E−05 | −8.573E−13 |

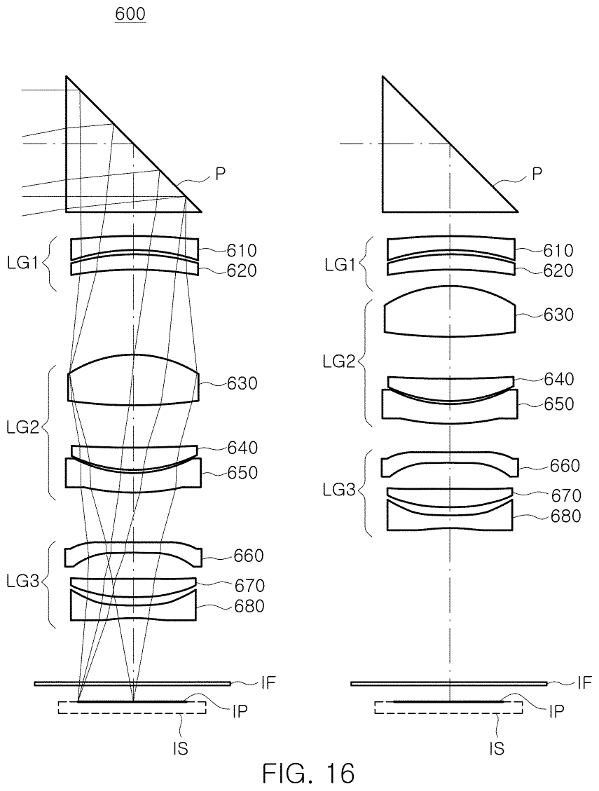

FIG. 16 is a configuration diagram of an imaging lens system according to a sixth embodiment of the present disclosure.

Referring to FIG. 16, an imaging lens system 600 may include a plurality of lens groups. For example, the imaging lens system 600 may include a first lens group LG1, a second lens group LG2, and a third lens group LG3 sequentially arranged in ascending numerical order along an optical axis of the imaging lens system 600 from an object side of the imaging lens system 600 toward an imaging plane IP of the imaging lens system 600. Each lens group of LG1, LG2, and LG3, may be comprised of a plurality of lenses. For example, the first lens group LG1 may be comprised of a first lens 610 and a second lens 620, the second lens group LG2 may be comprised of a third lens 630, a fourth lens 640, and a fifth lens 650, and the third lens group LG3 may be comprised of a sixth lens 660, a seventh lens 670, and an eighth lens 680. However, the lenses constituting the first lens group LG1 to the third lens group LG3 may not limited to the above-described forms.

The imaging lens system 600 may be configured to enable focus magnification adjustment (Zoom) and focus adjustment (AF). For example, the second lens group LG2 and the third lens group LG3 may be configured to be driven in the optical axis direction. Furthermore, the second lens group LG2 may be driven to enable focus magnification adjustment of the imaging lens system 600, and the third lens group LG3 may be driven to enable focus adjustment of the imaging lens system 600.

The imaging lens system 600 may further include an optical path conversion means (P). The optical path conversion means (P) may be configured in a prism form and may be disposed on an object side of the first lens group LG1.

The optical characteristics of the lenses constituting the first lens group LG1 to the third lens group LG3 are described below.

The first lens 610 may have a negative refractive power, and may have a convex object-side surface and a concave image-side surface. The second lens 620 may have a positive refractive power, and may have a convex object-side surface and a concave image-side surface. The third lens 630 may have a positive refractive power, and may have a convex object-side surface and a convex image-side surface. The fourth lens 640 may have a positive refractive power, and may have a concave object-side surface and a convex image-side surface. The fifth lens 650 may have a negative refractive power, and may have a concave object-side surface and a convex image-side surface. The sixth lens 660 may have a negative refractive power, and may have a concave object-side surface and a convex image-side surface. The seventh lens 670 may have a positive refractive power, and may have a concave object-side surface and a convex image-side surface. The eighth lens 680 may have a negative refractive power and a concave object-side surface and a concave image-side surface.

The imaging optical lens 600 may further include a filter (IF) and an imaging plane (IP). The imaging plane (IP) may be formed on an image sensor (IS), and the filter (IF) may be disposed between the eighth lens 680 and the imaging plane IP.

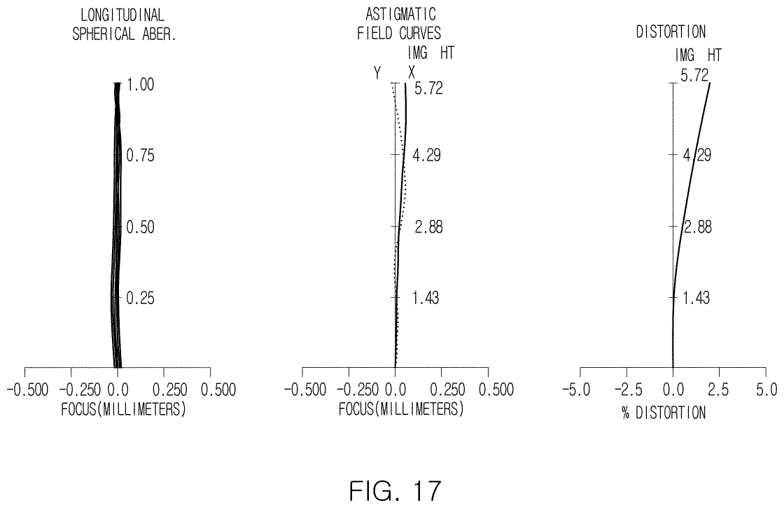

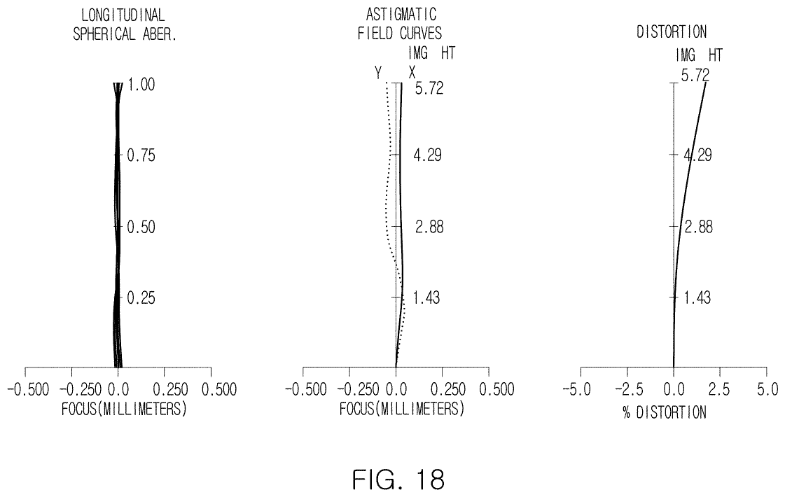

FIGS. 17 and 18 illustrate aberration curves of the imaging lens system according to the sixth embodiment.

Tables 11 and 12 below illustrate the lens characteristics and aspherical values of the imaging lens system according to the sixth embodiment.

TABLE 11

| | | | Thickness/ | Thickness/ | | |
|---|---|---|---|---|---|---|
| | | | Distance | Distance | | |
| Surface | | Radius of | (Wide-Angle | (Telephoto | Refractive | Abbe |
| No. | Component | Curvature | Mode) | Mode) | Index | No. |
| S1 | Prism | Infinity | 4.1500 | 4.1500 | 1.784 | 25.70 |
| S2 | | Infinity | 4.1500 | 4.1500 | 1.784 | 25.70 |
| S3 | | Infinity | 1.5000 | 1.5000 | | |
| S4 | 1st Lens | 39.8202 | 0.8600 | 0.8600 | 1.806 | 40.70 |
| S5 | | 12.1348 | 0.2291 | 0.2291 | | |
| S6 | 2nd Lens | 11.0174 | 0.9234 | 0.9234 | 1.671 | 19.20 |
| S7 | | 14.6819 | 5.2283 | 1.0400 | | |
| S8 | 3rd Lens | 7.0100 | 3.1174 | 3.1174 | 1.497 | 81.50 |
| S9 | | −18.4188 | 2.5823 | 2.5823 | | |
| S10 | 4th Lens | −42.9188 | 1.3392 | 1.3392 | 1.544 | 56.00 |
| S11 | | −7.4889 | 0.2111 | 0.2111 | | |
| S12 | 5th Lens | −5.4200 | 1.2000 | 1.2000 | 1.821 | 24.00 |
| S13 | | −9.2961 | 3.0808 | 1.7600 | | |
| S14 | 6th Lens | −15.0882 | 0.6200 | 0.6200 | 1.615 | 25.90 |
| S15 | | −85.4194 | 1.5913 | 1.5913 | | |
| S16 | 7th Lens | −434.9614 | 1.1405 | 1.1405 | 1.671 | 19.20 |
| S17 | | −12.8866 | 0.5000 | 0.5000 | | |
| S18 | 8th Lens | −41.2902 | 0.7500 | 0.7500 | 1.544 | 56.00 |
| S19 | | 7.2789 | 3.9447 | 9.4867 | | |
| S20 | Filter | Infinity | 0.2100 | 0.2100 | 1.516 | 64.10 |
| S21 | | Infinity | 0.9667 | 0.9340 | | |
| S22 | Imaging | Infinity | 0.0053 | 0.0051 | | |
| | Plane | | | | | |

TABLE 12

| Surface No. | S4 | S5 | S6 | S7 | S8 | S9 | S10 | S11 |
|---|---|---|---|---|---|---|---|---|
| k | 1.844E+01 | −1.121E+00 | −3.564E+00 | 2.056E+00 | −3.199E−01 | −9.900E+01 | 9.900E+01 | −7.850E+00 |
| A | −2.794E−01 | −2.012E−01 | −1.650E−01 | −6.939E−04 | 4.185E−02 | −6.070E−02 | 6.248E−02 | −1.748E−01 |
| B | 1.755E−02 | 3.380E−02 | 4.147E−03 | −2.092E−05 | 5.928E−03 | 2.727E−02 | −5.084E−03 | −2.274E−02 |
| C | 1.396E−04 | 1.395E−03 | −4.997E−03 | 6.209E−06 | 9.447E−04 | −6.303E−03 | 1.190E−02 | 1.830E−02 |
| D | 4.723E−04 | 2.998E−03 | 9.813E−05 | −9.414E−07 | 3.203E−04 | 2.097E−03 | 1.002E−04 | −2.780E−03 |
| E | −9.043E−04 | −3.708E−04 | −1.001E−03 | 9.410E−08 | 1.141E−05 | −6.362E−04 | 7.240E−04 | 1.477E−03 |
| F | 3.440E−04 | 2.164E−03 | 4.799E−04 | −6.084E−09 | 1.085E−06 | 2.052E−04 | 3.905E−04 | −4.444E−04 |
| G | −2.520E−04 | −3.633E−05 | −1.752E−04 | 2.404E−10 | −5.645E−06 | −7.516E−05 | 1.993E−04 | 6.941E−04 |
| H | 7.958E−05 | 4.087E−04 | 2.096E−04 | −5.267E−12 | −3.686E−06 | 2.125E−05 | 6.175E−05 | −4.249E−04 |
| J | −6.318E−05 | −2.194E−04 | 1.588E−05 | 4.893E−14 | 3.151E−06 | −2.688E−06 | 7.218E−06 | 4.101E−05 |

| Surface No. | S12 | S13 | S14 | S15 | S16 | S17 | S18 | S19 |
|---|---|---|---|---|---|---|---|---|
| k | −1.206E+01 | −4.192E+01 | −9.900E+01 | −9.900E+01 | −9.900E+01 | 0.000E+00 | 9.900E+01 | −3.301E+01 |
| A | −1.689E−01 | −6.404E−04 | 4.148E−01 | 6.559E−01 | −7.715E−02 | −2.576E−03 | −1.642E+00 | −2.923E−03 |
| B | 2.993E−02 | 4.431E−02 | −2.663E−02 | −4.210E−02 | 1.625E−02 | 1.089E−03 | 2.954E−02 | 4.928E−04 |
| C | −1.050E−02 | −1.318E−02 | 4.123E−03 | 1.061E−02 | 3.864E−02 | −2.205E−04 | −2.056E−01 | −1.019E−04 |
| D | 4.159E−03 | 5.302E−03 | 1.400E−04 | −1.673E−04 | −1.174E−02 | 1.724E−05 | 8.070E−03 | 1.649E−05 |
| E | −7.778E−04 | −1.499E−03 | −6.360E−04 | −6.110E−04 | −1.478E−02 | 4.660E−07 | 2.505E−02 | −1.724E−06 |
| F | −1.727E−04 | 3.053E−04 | 1.125E−04 | −2.168E−05 | −3.755E−03 | −1.972E−07 | 4.878E−02 | 1.112E−07 |
| G | 2.278E−04 | −1.009E−04 | −6.959E−06 | 1.138E−05 | −5.649E−05 | 1.519E−08 | 2.775E−02 | −4.301E−09 |
| H | −7.107E−05 | 5.156E−06 | −2.353E−07 | −5.803E−06 | 8.096E−04 | −5.005E−10 | 1.230E−02 | 9.165E−11 |
| J | 7.205E−07 | −7.007E−06 | −3.976E−07 | 1.577E−06 | 3.399E−04 | 6.012E−12 | 8.070E−04 | −8.292E−13 |

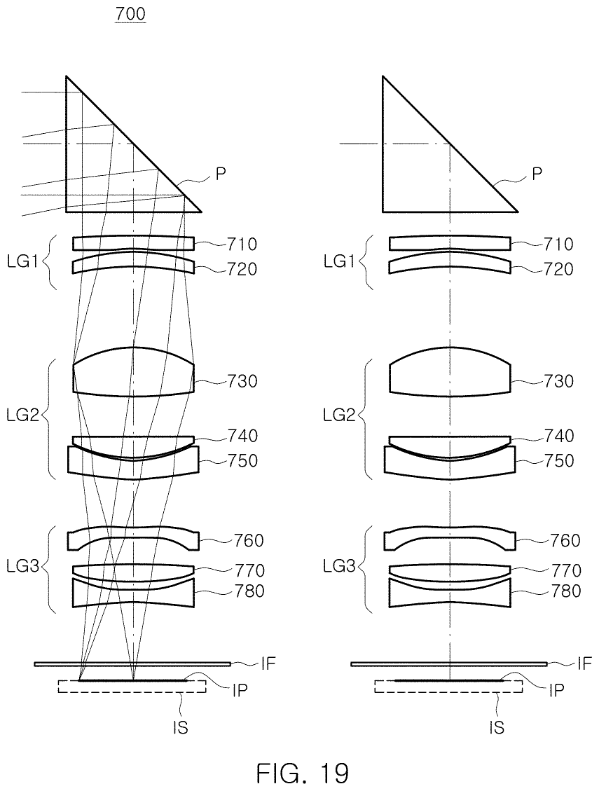

FIG. 19 is a configuration diagram of an imaging lens system according to a seventh embodiment of the present disclosure.

Referring to FIG. 19, an imaging lens system 700 may include a plurality of lens groups. For example, the imaging lens system 700 may include a first lens group LG1, a second lens group LG2, and a third lens group LG3 sequentially arranged in ascending numerical order along an optical axis of the imaging lens system 700 from an object side of the imaging lens system 700 toward an imaging plane IP of the imaging lens system 700. Each lens group LG1, LG2, and LG3, may be comprised of a plurality of lenses. For example, the first lens group LG1 may be comprised of a first lens 710 and a second lens 720, the second lens group LG2 may be comprised of a third lens 730, a fourth lens 740, and a fifth lens 750, and the third lens group LG3 may be comprised of a sixth lens 760, a seventh lens 770, and an eighth lens 780. However, the lenses constituting the first lens group LG1 to the third lens group LG3 may not limited to the above-described forms.

The imaging lens system 700 may be configured to enable focus magnification adjustment (Zoom) and focus adjustment (AF). For example, the second lens group LG2 and the third lens group LG3 may be configured to be driven in the optical axis direction. Furthermore, the second lens group LG2 may be driven to enable focus magnification adjustment of the imaging lens system 700, and the third lens group LG3 may be driven to enable focus adjustment of the imaging lens system 700.

The imaging lens system 700 may further include an optical path conversion means (P). The optical path conversion means (P) may be configured in a prism form and may be disposed on an object side of the first lens group LG1.

The optical characteristics of the lenses constituting the first lens group LG1 to the third lens group LG3 are described below.

The first lens 710 may have a negative refractive power, and may have a convex object-side surface and a concave image-side surface. The second lens 720 may have a positive refractive power, and may have a convex object-side surface and a concave image-side surface. The third lens 730 may have a positive refractive power, and may have a convex object-side surface and a convex image-side surface. The fourth lens 740 may have a positive refractive power, and may have a concave object-side surface and a convex image-side surface. The fifth lens 750 may have a negative refractive power, and may have a concave object-side surface and a convex image-side surface. The sixth lens 760 may have a negative refractive power, and may have a concave object-side surface and a convex image-side surface. The seventh lens 770 may have a positive refractive power, and may have a convex object-side surface and a convex image-side surface. The eighth lens 780 may have a negative refractive power and may have a concave object-side surface and a concave image-side surface.

The imaging lens system 700 may further include a filter (IF) and an imaging plane (IP). The imaging plane (IP) may be formed on an image sensor (IS), and the filter (IF) may be disposed between the eighth lens 780 and the imaging plane (IP).

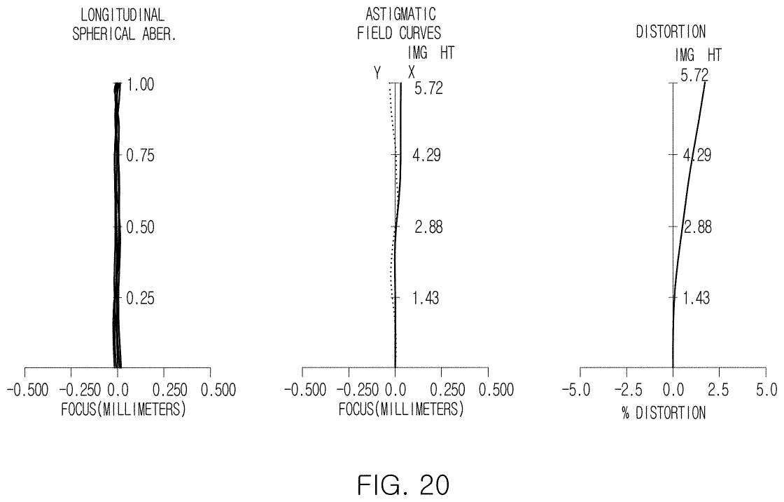

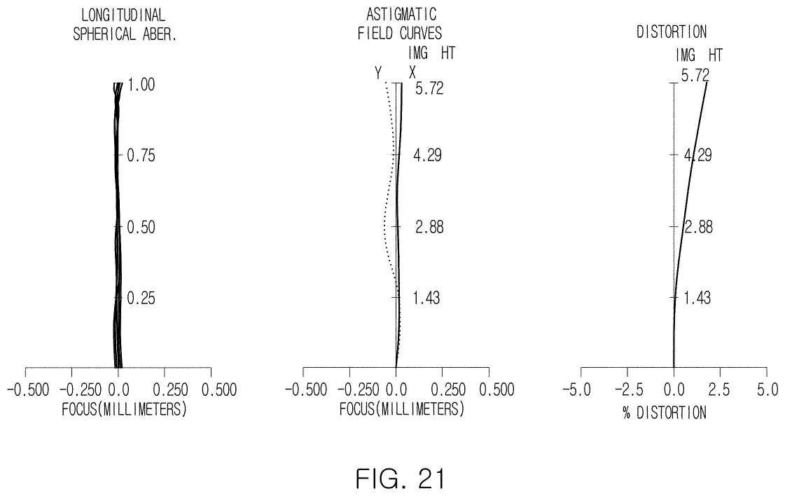

FIGS. 20 and 21 illustrate aberration curves of the imaging lens system according to the seventh embodiment.

Tables 13 and 14 below illustrate the lens characteristics and aspherical values of the imaging lens system according to the seventh embodiment.

TABLE 13

| | | | Thickness/ | Thickness/ | | |
|---|---|---|---|---|---|---|
| | | | Distance | Distance | | |
| Surface | | Radius of | (Wide-Angle | (Telephoto | Refractive | Abbe |
| No. | Component | Curvature | Mode) | Mode) | Index | No. |
| S1 | Prism | Infinity | 4.1500 | 4.1500 | 1.784 | 25.70 |
| S2 | | Infinity | 4.1500 | 4.1500 | 1.784 | 25.70 |
| S3 | | Infinity | 1.5000 | 1.5000 | | |
| S4 | 1st Lens | 32.4350 | 0.8600 | 0.8600 | 1.806 | 40.70 |
| S5 | | 11.5397 | 0.1918 | 0.1918 | | |
| S6 | 2nd Lens | 9.9804 | 0.9310 | 0.9310 | 1.671 | 19.20 |
| S7 | | 12.4825 | 5.2181 | 1.0400 | | |
| S8 | 3rd Lens | 7.0100 | 3.1268 | 3.1268 | 1.497 | 81.50 |
| S9 | | −18.4531 | 2.6035 | 2.6035 | | |
| S10 | 4th Lens | −42.8719 | 1.3135 | 1.3135 | 1.544 | 56.00 |
| S11 | | −7.8300 | 0.1826 | 0.1826 | | |
| S12 | 5th Lens | −5.5816 | 1.2000 | 1.2000 | 1.821 | 24.00 |
| S13 | | −9.3120 | 3.0936 | 1.7600 | | |
| S14 | 6th Lens | −14.1275 | 0.6200 | 0.6200 | 1.615 | 25.90 |
| S15 | | −128.7703 | 1.6939 | 1.6939 | | |
| S16 | 7th Lens | 30.7531 | 1.1548 | 1.1548 | 1.671 | 19.20 |
| S17 | | −22.1083 | 0.5156 | 0.5156 | | |
| S18 | 8th Lens | −42.5336 | 0.7500 | 0.7500 | 1.544 | 56.00 |
| S19 | | 7.7062 | 3.8971 | 9.4106 | | |
| S20 | Filter | Infinity | 0.2100 | 0.2100 | 1.516 | 64.10 |
| S21 | | Infinity | 0.9327 | 0.9309 | | |
| S22 | Imaging | Infinity | 0.0051 | 0.0053 | | |
| | Plane | | | | | |

TABLE 14

| Surface No. | S4 | S5 | S6 | S7 | S8 | S9 | S10 | S11 |
|---|---|---|---|---|---|---|---|---|
| k | 1.324E+01 | −1.091E+00 | −3.489E+00 | 5.108E−01 | −3.319E−01 | −9.900E+01 | 9.900E+01 | −6.466E+00 |
| A | −2.866E−01 | −1.961E−01 | −1.601E−01 | −9.415E−04 | 3.646E−02 | −7.947E−02 | −1.073E−02 | −1.973E−01 |
| B | −1.285E−03 | 3.324E−03 | 9.956E−03 | −1.419E−05 | 4.806E−03 | 2.600E−02 | 1.024E−02 | −3.171E−03 |
| C | 5.296E−03 | 7.017E−03 | −2.632E−03 | 6.560E−06 | 8.563E−04 | −6.056E−03 | 1.400E−02 | 6.866E−03 |
| D | −1.180E−03 | −4.845E−03 | −1.429E−03 | −9.511E−07 | 3.254E−04 | 1.945E−03 | 2.328E−03 | 1.215E−03 |
| E | −3.307E−04 | −1.213E−03 | 4.588E−04 | 9.374E−08 | 1.244E−05 | −5.816E−04 | 1.401E−03 | −9.400E−04 |
| F | 7.882E−05 | −7.334E−04 | −5.230E−05 | −6.080E−09 | 6.407E−06 | 1.929E−04 | 1.016E−03 | 5.944E−04 |
| G | −5.343E−05 | −8.826E−04 | 1.100E−04 | 2.408E−10 | −4.278E−06 | −6.837E−05 | 3.781E−04 | 2.491E−04 |
| H | 1.089E−05 | −6.613E−04 | 1.980E−04 | −5.261E−12 | −5.874E−06 | 1.709E−05 | 1.475E−04 | −1.180E−04 |
| J | −3.889E−05 | −4.747E−04 | −8.235E−06 | 4.858E−14 | 5.763E−06 | −1.819E−06 | 1.517E−05 | −4.278E−05 |

| Surface No. | S12 | S13 | S14 | S15 | S16 | S17 | S18 | S19 |
|---|---|---|---|---|---|---|---|---|
| k | −1.296E+01 | −4.501E+01 | −9.900E+01 | −9.900E+01 | −9.900E+01 | 0.000E+00 | 9.900E+01 | −3.301E+01 |
| A | −1.729E−01 | −3.645E−02 | 4.106E−01 | 6.646E−01 | −8.861E−02 | −2.015E−03 | −8.728E−01 | −2.045E−03 |
| B | 3.596E−02 | 5.434E−02 | −2.796E−02 | −4.600E−02 | −6.708E−02 | 9.217E−04 | 2.925E−01 | 3.958E−04 |
| C | −1.187E−02 | −1.546E−02 | 3.604E−03 | 1.024E−02 | 8.482E−03 | −2.062E−04 | −1.899E−02 | −9.227E−05 |
| D | 4.071E−03 | 6.248E−03 | 1.324E−04 | −6.337E−04 | −2.239E−02 | 1.716E−05 | 6.402E−02 | 1.614E−05 |
| E | −9.873E−04 | −2.181E−03 | −5.924E−04 | −4.136E−04 | −1.880E−02 | 4.428E−07 | 2.910E−02 | −1.733E−06 |
| F | 1.349E−04 | 5.041E−04 | 1.667E−04 | 2.262E−05 | −7.188E−03 | −1.978E−07 | 2.853E−02 | 1.119E−07 |
| G | −3.320E−05 | −2.625E−04 | −3.790E−05 | −2.993E−06 | −1.944E−03 | 1.521E−08 | 1.605E−02 | −4.285E−09 |
| H | 1.974E−05 | 3.246E−05 | 6.715E−06 | −6.177E−06 | 2.104E−04 | −4.983E−10 | 8.939E−03 | 9.005E−11 |
| J | −3.682E−06 | −3.641E−05 | −1.048E−06 | 1.834E−06 | 1.966E−04 | 5.986E−12 | 9.507E−04 | −8.030E−13 |

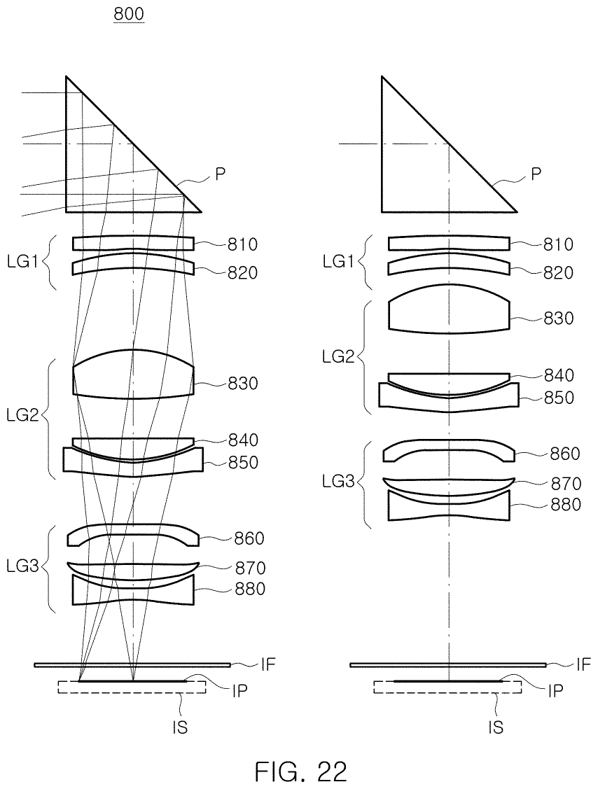

FIG. 22 is a configuration diagram of an imaging lens system according to an eighth embodiment of the present disclosure.

Referring to FIG. 22, an imaging lens system 800 may include a plurality of lens groups. For example, the imaging lens system 800 may include a first lens group LG1, a second lens group LG2, and a third lens group LG3 sequentially arranged in ascending numerical order along an optical axis of the imaging lens system 800 from an object side of the imaging lens system 800 toward an imaging plane IP of the imaging lens system 800. Each lens group of LG1, LG2, and LG3, may be comprised of a plurality of lenses. For example, the first lens group LG1 may be comprised of a first lens 810 and a second lens 820, the second lens group LG2 may be comprised of a third lens 830, a fourth lens 840, and a fifth lens 850, and the third lens group LG3 may be comprised of a sixth lens 860, a seventh lens 870, and an eighth lens 880. However, the lenses constituting the first lens group LG1 to the third lens group LG3 may not limited to the above-described forms.

The imaging lens system 800 may be configured to enable focus magnification adjustment (Zoom) and focus adjustment (AF). For example, the second lens group LG2 and the third lens group LG3 may be configured to be driven in the optical axis direction. Furthermore, the second lens group LG2 may be driven to enable focus magnification adjustment of the imaging lens system 800, and the third lens group LG3 may be driven to enable focus adjustment of the imaging lens system 800.

The imaging lens system 800 may further include an optical path conversion means (P). The optical path conversion means (P) may be configured in a prism form and may be disposed on an object side of the first lens group LG1.

The optical characteristics of the lenses constituting the first lens group LG1 to the third lens group LG3 are described below.

The first lens 810 may have a negative refractive power, and may have a convex object-side surface and a concave image-side surface. The second lens 820 may have a positive refractive power, and may have a convex object-side surface and a concave image-side surface. The third lens 830 may have a positive refractive power, and may have a convex object-side surface and a convex image-side surface. The fourth lens 840 may have a positive refractive power, and may have a concave object-side surface and a convex image-side surface. The fifth lens 850 may have a negative refractive power, and may have a concave object-side surface and a convex image-side surface. The sixth lens 860 may have a negative refractive power, and may have a concave object-side surface and a concave image-side surface. The seventh lens 870 may have a positive refractive power, and may have a convex object-side surface and a convex image-side surface. The eighth lens 880 may have a negative refractive power and may have a concave object-side surface and a concave image-side surface.

The imaging lens system 800 may further include a filter (IF) and an imaging plane (IP). The imaging plane (IP) may be formed on an image sensor (IS), and the filter (IF) may be disposed between the eighth lens 880 and the imaging plane (IP).

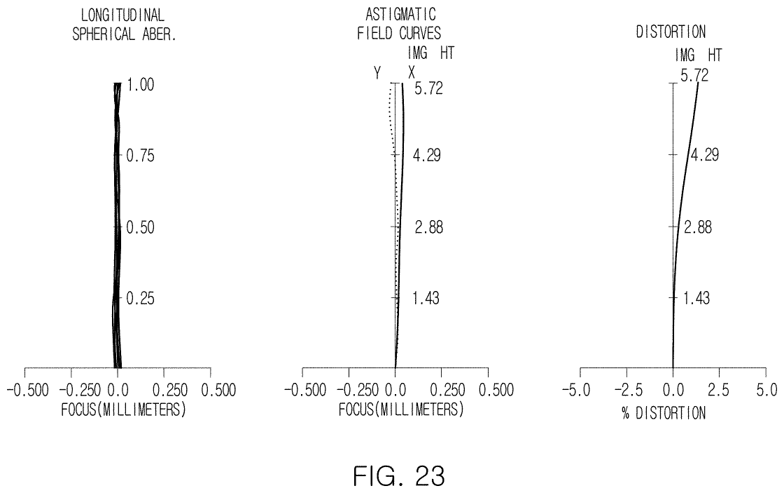

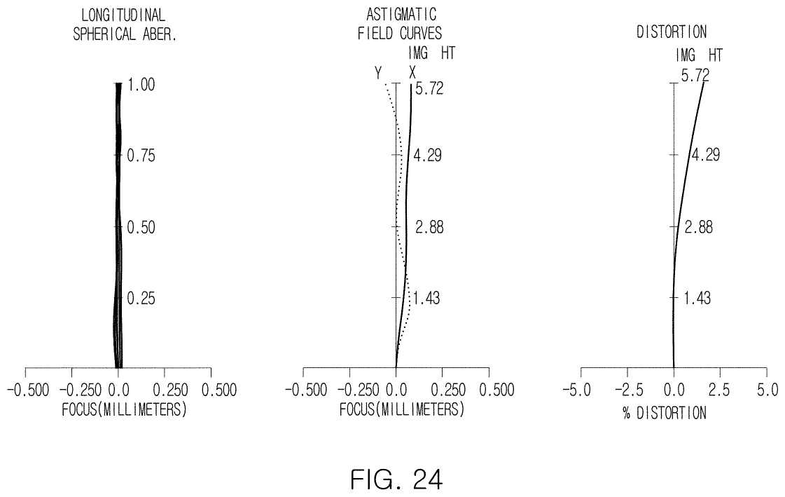

FIGS. 23 and 24 illustrate aberration curves of the imaging lens system according to the eighth embodiment.

Tables 15 and 16 below illustrate the lens characteristics and aspherical values of the imaging lens system according to the eighth embodiment.

TABLE 15

| | | | Thickness/ | Thickness/ | | |
|---|---|---|---|---|---|---|
| | | | Distance | Distance | | |
| Surface | | Radius of | (Wide-Angle | (Telephoto | Refractive | Abbe |
| No. | Component | Curvature | Mode) | Mode) | Index | No. |
| S1 | Prism | Infinity | 4.1500 | 4.1500 | 1.784 | 25.70 |
| S2 | | Infinity | 4.1500 | 4.1500 | 1.784 | 25.70 |
| S3 | | Infinity | 1.5000 | 1.5000 | | |
| S4 | 1st Lens | 23.4658 | 0.8600 | 0.8600 | 1.806 | 40.70 |
| S5 | | 9.9719 | 0.3064 | 0.3064 | | |
| S6 | 2nd Lens | 10.6433 | 0.9315 | 0.9315 | 1.671 | 19.20 |
| S7 | | 13.4799 | 5.1870 | 1.0400 | | |
| S8 | 3rd Lens | 7.0100 | 3.1293 | 3.1293 | 1.497 | 81.50 |
| S9 | | −18.1928 | 2.5834 | 2.5834 | | |
| S10 | 4th Lens | −44.7521 | 1.3362 | 1.3362 | 1.544 | 56.00 |
| S11 | | −8.2823 | 0.1800 | 0.1800 | | |
| S12 | 5th Lens | −5.4200 | 0.9200 | 0.9200 | 1.821 | 24.00 |
| S13 | | −8.7189 | 3.0362 | 1.7600 | | |
| S14 | 6th Lens | −27.9716 | 0.6200 | 0.6200 | 1.615 | 25.90 |
| S15 | | 70.4989 | 1.9114 | 1.9114 | | |
| S16 | 7th Lens | 64.6251 | 1.0296 | 1.0296 | 1.671 | 19.20 |
| S17 | | −17.7793 | 0.5000 | 0.5000 | | |
| S18 | 8th Lens | −40.3219 | 0.7500 | 0.7500 | 1.544 | 56.00 |
| S19 | | 7.6233 | 4.0736 | 9.4969 | | |
| S20 | Filter | Infinity | 0.2100 | 0.2100 | 1.516 | 64.10 |
| S21 | | Infinity | 0.9300 | 0.9300 | | |
| S22 | Imaging | Infinity | 0.0053 | 0.0053 | | |
| | Plane | | | | | |

TABLE 16

| Surface No. | S4 | S5 | S6 | S7 | S8 | S9 | S10 | S11 |
|---|---|---|---|---|---|---|---|---|
| k | 3.751E+00 | −1.687E+00 | −3.399E+00 | 1.236E+00 | −3.874E−01 | −9.900E+01 | 9.900E+01 | −6.663E+00 |
| A | −3.424E−01 | −2.386E−01 | −1.588E−01 | −7.624E−04 | 2.040E−02 | −8.930E−02 | 1.100E−02 | −1.936E−01 |
| B | 1.395E−02 | 2.082E−02 | 2.543E−03 | −3.187E−05 | −4.108E−03 | 2.189E−02 | −1.819E−03 | −8.469E−03 |
| C | 1.101E−03 | 4.087E−03 | −1.419E−03 | 7.276E−06 | −2.186E−03 | −6.581E−03 | 1.335E−02 | 5.850E−03 |
| D | 1.558E−04 | −4.918E−04 | −1.559E−03 | −9.553E−07 | −6.217E−04 | 1.791E−03 | 8.954E−04 | 2.172E−03 |
| E | −3.330E−04 | −3.096E−04 | 4.586E−04 | 9.313E−08 | −2.985E−04 | −6.222E−04 | 4.126E−04 | −2.039E−03 |
| F | 1.340E−04 | 3.374E−04 | −8.385E−06 | −6.084E−09 | −3.859E−05 | 1.973E−04 | 4.915E−04 | 8.344E−04 |
| G | −3.393E−05 | −5.868E−05 | 1.204E−06 | 2.415E−10 | −3.653E−05 | −6.101E−05 | −8.661E−05 | −3.020E−04 |
| H | 1.633E−05 | 9.857E−05 | 1.483E−04 | −5.239E−12 | −6.487E−06 | 1.193E−05 | 1.409E−05 | 6.869E−05 |
| J | −6.607E−06 | −8.279E−05 | 1.283E−05 | 4.764E−14 | −1.211E−06 | −1.098E−06 | −1.701E−05 | −5.213E−05 |

| Surface No. | S12 | S13 | S14 | S15 | S16 | S17 | S18 | S19 |
|---|---|---|---|---|---|---|---|---|
| k | −1.268E+01 | −3.330E+01 | −9.900E+01 | −9.900E+01 | −9.900E+01 | 0.000E+00 | 9.900E+01 | −3.301E+01 |
| A | −1.236E−01 | 5.787E−02 | 4.198E−01 | 6.048E−01 | −1.470E−01 | −1.378E−03 | −7.808E−01 | −3.645E−03 |
| B | 3.472E−02 | 2.858E−02 | −3.236E−02 | −3.441E−02 | −9.780E−02 | 7.480E−04 | 3.559E−01 | 7.323E−04 |
| C | −1.513E−02 | −1.106E−02 | 7.232E−03 | 1.261E−02 | 2.853E−03 | −1.821E−04 | 8.917E−03 | −1.247E−04 |
| D | 5.507E−03 | 3.942E−03 | −6.555E−04 | −5.982E−04 | −2.767E−02 | 1.639E−05 | 6.498E−02 | 1.749E−05 |
| E | −1.593E−03 | −1.006E−03 | −1.791E−04 | −6.175E−04 | −2.432E−02 | 3.461E−07 | 1.557E−02 | −1.725E−06 |
| F | 4.402E−04 | 2.387E−04 | −5.523E−06 | −1.091E−04 | −1.043E−02 | −1.979E−07 | 1.416E−02 | 1.098E−07 |
| G | −1.390E−04 | −8.306E−05 | −7.833E−06 | −4.876E−05 | −1.894E−03 | 1.563E−08 | 6.717E−03 | −4.299E−09 |
| H | 3.384E−05 | 1.903E−05 | 1.675E−06 | 1.263E−05 | 6.421E−04 | −4.754E−10 | 4.501E−03 | 9.469E−11 |
| J | −4.159E−06 | −2.542E−06 | 8.239E−07 | 1.212E−05 | 4.075E−04 | 4.186E−12 | 5.093E−04 | −9.010E−13 |

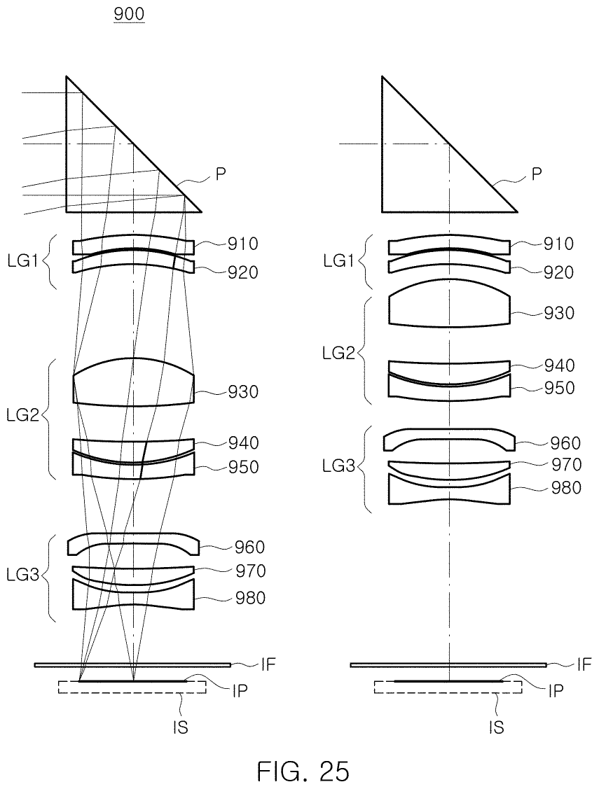

FIG. 25 is a configuration diagram of an imaging lens system according to a ninth embodiment of the present disclosure.

Referring to FIG. 25, an imaging lens system 900 may include a plurality of lens groups. For example, the imaging lens system 900 may include a first lens group LG1, a second lens group LG2, and a third lens group LG3 sequentially arranged in ascending numerical order along an optical axis of the imaging lens system 900 from an object side of the imaging lens system 900 toward an imaging plane IP of the imaging lens system 900. Each lens group of LG1, LG2, and LG3, may be comprised of a plurality of lenses. For example, the first lens group LG1 may be comprised of a first lens 910 and a second lens 920, the second lens group LG2 may be comprised of a third lens 930, a fourth lens 940, and a fifth lens 950, and the third lens group LG3 may be comprised of a sixth lens 960, a seventh lens 970, and an eighth lens 980. However, the lenses constituting the first lens group LG1 to the third lens group LG3 may not limited to the above-described forms.

The imaging lens system 900 may be configured to enable focus magnification adjustment (Zoom) and focus adjustment (AF). For example, the second lens group LG2 and the third lens group LG3 may be configured to be driven in the optical axis direction. Furthermore, the second lens group LG2 may be driven to enable focus magnification adjustment of the imaging lens system 900, and the third lens group LG3 may be driven to enable focus adjustment of the imaging lens system 900.

The imaging lens system 900 may further include an optical path conversion means (P). The optical path conversion means (P) may be configured in a prism form and may be disposed on an object side of the first lens group LG1.

The optical characteristics of the lenses constituting the first lens group LG1 to the third lens group LG3 are described below.

The first lens 910 may have a negative refractive power, and may have a convex object-side surface and a concave image-side surface. The second lens 920 may have a positive refractive power, and may have a convex object-side surface and a concave image-side surface. The third lens 930 may have a positive refractive power, and may have a convex object-side surface and a convex image-side surface. The fourth lens 940 may have a positive refractive power, and may have a concave object-side surface and a convex image-side surface. The fifth lens 950 may have a negative refractive power, and may have a concave object-side surface and a convex image-side surface. The sixth lens 960 may have a negative refractive power, and may have a concave object-side surface and a convex image-side surface. The seventh lens 970 may have a positive refractive power, and may have a convex object-side surface and a convex image-side surface. The eighth lens 980 may have a negative refractive power and may have a concave object-side surface and a concave image-side surface.

The imaging lens system 900 may further include a filter (IF) and an imaging plane (IP). The imaging plane (IP) may be formed on an imaging sensor (IS), and the filter (IF) may be disposed between the eighth lens 980 and the imaging plane (IP).

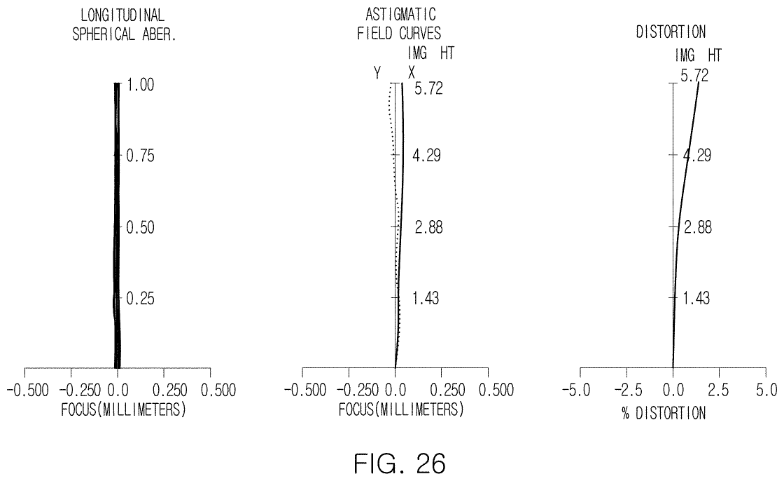

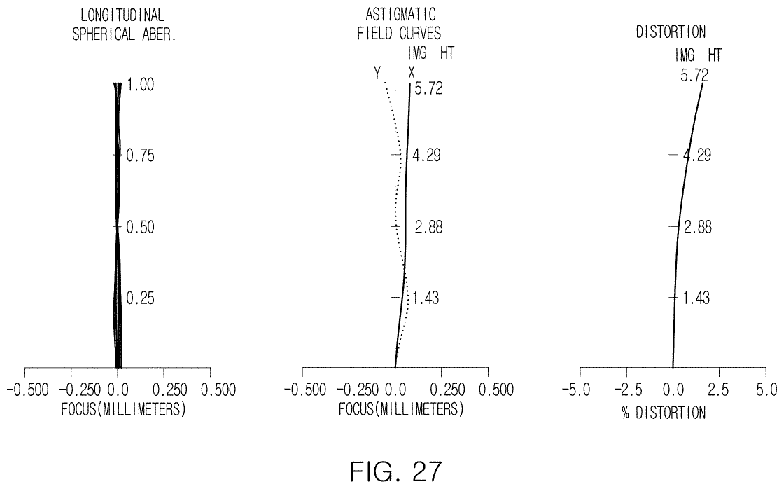

FIGS. 26 and 27 illustrate aberration curves of the imaging lens system according to the ninth embodiment.

Tables 17 and 18 below illustrate the lens characteristics and aspherical values of the imaging lens system according to the ninth embodiment.

TABLE 17

| | | | Thickness/ | Thickness/ | | |
|---|---|---|---|---|---|---|
| | | | Distance | Distance | | |
| Surface | | Radius of | (Wide-Angle | (Telephoto | Refractive | Abbe |
| No. | Component | Curvature | Mode) | Mode) | Index | No. |
| S1 | Prism | Infinity | 4.1500 | 4.1500 | 1.784 | 25.70 |
| S2 | | Infinity | 4.1500 | 4.1500 | 1.784 | 25.70 |
| S3 | | Infinity | 1.5000 | 1.5000 | | |
| S4 | 1st Lens | 11.9079 | 0.8600 | 0.8600 | 1.806 | 40.70 |
| S5 | | 7.4198 | 0.1000 | 0.1000 | | |
| S6 | 2nd Lens | 8.7655 | 0.8884 | 0.8884 | 1.671 | 19.20 |
| S7 | | 9.9038 | 6.0096 | 1.0400 | | |
| S8 | 3rd Lens | 7.0100 | 3.0775 | 3.0775 | 1.497 | 81.50 |
| S9 | | −19.6501 | 2.2427 | 2.2427 | | |
| S10 | 4th Lens | −46.9635 | 1.3321 | 1.3321 | 1.544 | 56.00 |
| S11 | | −8.8933 | 0.1800 | 0.1800 | | |
| S12 | 5th Lens | −6.2844 | 0.9200 | 0.9200 | 1.821 | 24.00 |
| S13 | | −10.3902 | 3.4596 | 1.7600 | | |
| S14 | 6th Lens | −11.3932 | 0.6210 | 0.6210 | 1.615 | 25.90 |
| S15 | | −22.1479 | 1.5946 | 1.5946 | | |
| S16 | 7th Lens | 261.8664 | 1.0635 | 1.0635 | 1.671 | 19.20 |
| S17 | | −16.1199 | 0.5000 | 0.5000 | | |
| S18 | 8th Lens | −40.5804 | 0.7500 | 0.7500 | 1.544 | 56.00 |
| S19 | | 7.2216 | 3.7531 | 10.4200 | | |
| S20 | Filter | Infinity | 0.2100 | 0.2100 | 1.516 | 64.10 |
| S21 | | Infinity | 0.9329 | 0.9350 | | |
| S22 | Imaging | Infinity | 0.0051 | 0.0053 | | |
| | Plane | | | | | |

TABLE 18

| Surface No. | S4 | S5 | S6 | S7 | S8 | S9 | S10 | S11 |
|---|---|---|---|---|---|---|---|---|
| k | −1.422E+00 | −2.302E+00 | −2.255E+00 | 6.451E−01 | −2.904E−01 | −9.900E+01 | 9.900E+01 | −9.081E+00 |
| A | −4.066E−01 | −2.917E−01 | −9.431E−02 | −9.889E−04 | 5.292E−02 | 8.297E−03 | 1.110E−01 | −1.560E−01 |
| B | 9.259E−03 | 3.143E−03 | 4.120E−02 | −3.241E−05 | −3.790E−03 | −1.064E−03 | −2.390E−02 | −1.908E−02 |
| C | −1.838E−05 | 2.144E−03 | 3.671E−03 | 7.614E−06 | −2.706E−03 | −9.705E−03 | 2.015E−02 | 2.048E−02 |
| D | 6.597E−04 | 4.120E−04 | −2.462E−03 | −9.454E−07 | −5.450E−04 | 1.388E−03 | 1.840E−03 | 1.101E−04 |
| E | −1.317E−04 | 1.168E−04 | 8.356E−04 | 9.335E−08 | −2.305E−04 | −1.025E−03 | −3.427E−04 | −1.732E−03 |
| F | 2.149E−05 | −1.978E−04 | −2.751E−04 | −6.086E−09 | −3.325E−05 | 2.030E−04 | 2.835E−04 | 1.447E−03 |
| G | −2.142E−05 | −7.032E−05 | 6.390E−05 | 2.409E−10 | −2.339E−05 | −8.061E−05 | 1.857E−05 | −8.323E−04 |
| H | 9.854E−06 | 1.557E−04 | 1.999E−04 | −5.263E−12 | −2.059E−06 | 3.314E−05 | 2.789E−05 | 6.078E−05 |
| J | −1.559E−06 | −4.327E−05 | −5.328E−05 | 4.872E−14 | −7.022E−08 | −6.912E−06 | −1.692E−05 | −1.182E−04 |
| Surface No. | S12 | S13 | S14 | S15 | S16 | S17 | S18 | S19 |
| k | −1.748E+01 | −5.507E+01 | −9.900E+01 | −9.900E+01 | −9.900E+01 | 1.076E+01 | 9.900E+01 | −3.301E+01 |
| A | −1.222E−01 | 4.683E−02 | 4.243E−01 | 6.807E−01 | −2.354E−01 | −2.614E−01 | −9.789E−01 | −2.103E−03 |
| B | 3.039E−02 | 2.973E−02 | −1.490E−02 | −4.002E−02 | 1.483E−03 | 2.980E−02 | 2.796E−01 | 5.905E−04 |
| C | −1.551E−02 | −1.373E−02 | −2.042E−04 | 1.072E−02 | 2.243E−03 | −1.391E−03 | −2.769E−02 | −1.264E−04 |
| D | 4.832E−03 | 3.931E−03 | 1.450E−03 | −8.168E−04 | −2.528E−02 | 1.106E−02 | 6.148E−02 | 1.805E−05 |
| E | −1.868E−03 | −9.255E−04 | −1.090E−03 | −2.225E−04 | −2.116E−02 | −2.893E−03 | 1.770E−02 | −1.738E−06 |
| F | 6.603E−04 | 3.048E−04 | 3.423E−04 | −6.251E−05 | −7.002E−03 | −5.135E−04 | 2.868E−02 | 1.096E−07 |
| G | −2.098E−04 | −1.195E−04 | −1.095E−04 | 1.989E−05 | −3.238E−04 | −1.117E−03 | 1.162E−02 | −4.301E−09 |
| H | 5.453E−05 | 3.481E−05 | 1.157E−05 | −4.804E−05 | 1.214E−03 | −5.912E−05 | 5.240E−03 | 9.498E−11 |
| J | −7.515E−06 | −4.353E−06 | 1.458E−06 | 1.378E−05 | 4.655E−04 | 2.685E−05 | 5.006E−05 | −9.008E−13 |

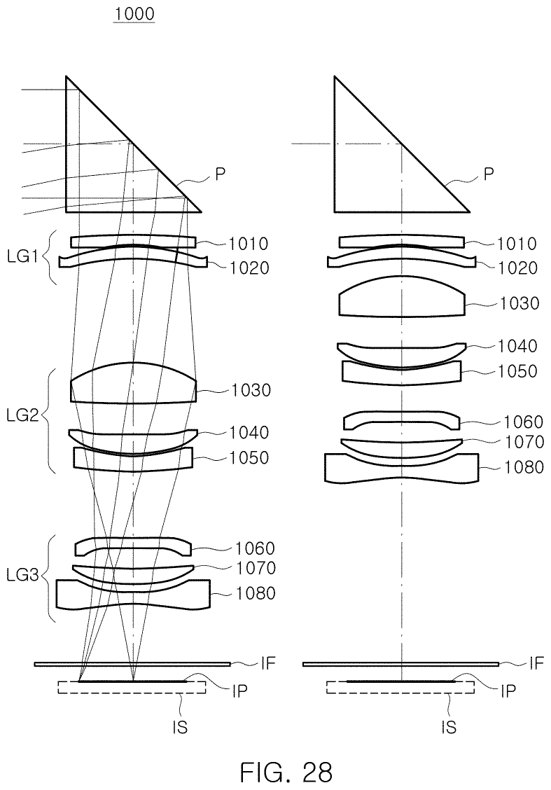

FIG. 28 is a configuration diagram of an imaging lens system according to a tenth embodiment of the present disclosure.

Referring to FIG. 28, an imaging lens system 1000 may include a plurality of lens groups. For example, the imaging lens system 1000 may include a first lens group LG1, a second lens group LG2, and a third lens group LG3 sequentially arranged in ascending numerical order along an optical axis of the imaging lens system 1000 from an object side of the imaging lens system 1000 toward an imaging plane IP of the imaging lens system 1000. Each lens group of LG1, LG2, and LG3, may be comprised of a plurality of lenses. For example, the first lens group LG1 may be comprised of a first lens 1010 and a second lens 1020, the second lens group LG2 may be comprised of a third lens 1030, a fourth lens 1040, and a fifth lens 1050, and the third lens group LG3 may be comprised of a sixth lens 1060, a seventh lens 1070, and an eighth lens 1080. However, the lenses constituting the first lens group LG1 to the third lens group LG3 may not limited to the above-described forms.

The imaging lens system 1000 may be configured to enable focus magnification adjustment (Zoom) and focus adjustment (AF). For example, the second lens group LG2 and the third lens group LG3 may be configured to be driven in the optical axis direction. Furthermore, the second lens group LG2 may be driven to enable focus magnification adjustment of the imaging lens system 1000, and the third lens group LG3 may be driven to enable focus adjustment of the imaging lens system 1000.

The imaging lens system 1000 may further include an optical path conversion means (P). The optical path conversion means (P) may be configured in a prism form and may be disposed on an object side of the first lens group LG1.

The optical characteristics of the lenses constituting the first lens group LG1 to the third lens group LG3 are described below.

The first lens 1010 may have a negative refractive power, and may have a convex object-side surface and a concave image-side surface. The second lens 1020 may have a positive refractive power, and may have a convex object-side surface and a concave image-side surface. The third lens 1030 may have a positive refractive power, and may have a convex object-side surface and a convex image-side surface. The fourth lens 1040 may have a positive refractive power, and may have a concave object-side surface and a convex image-side surface. The fifth lens 1050 may have a negative refractive power, and may have a concave object-side surface and a convex image-side surface. The sixth lens 1060 may have a negative refractive power, and may have a concave object-side surface and a convex image-side surface. The seventh lens 1070 may have a positive refractive power, and may have a concave object-side surface a convex image-side surface. The eighth lens 1080 may have a negative refractive power and may have a concave object-side surface and a concave image-side surface.

The imaging lens system 1000 may further include a filter (IF) and an imaging plane (IP). The imaging plane (IP) may be formed on an image sensor (IS), and the filter (IF) may be disposed between the eighth lens 1080 and the imaging plane (IP).

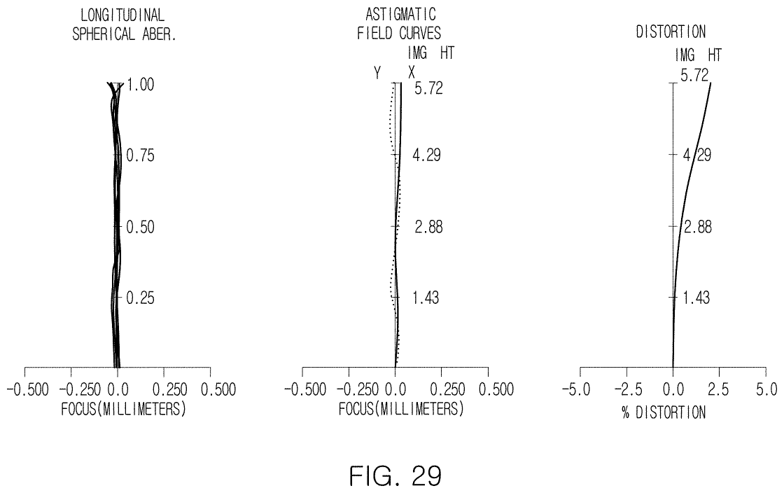

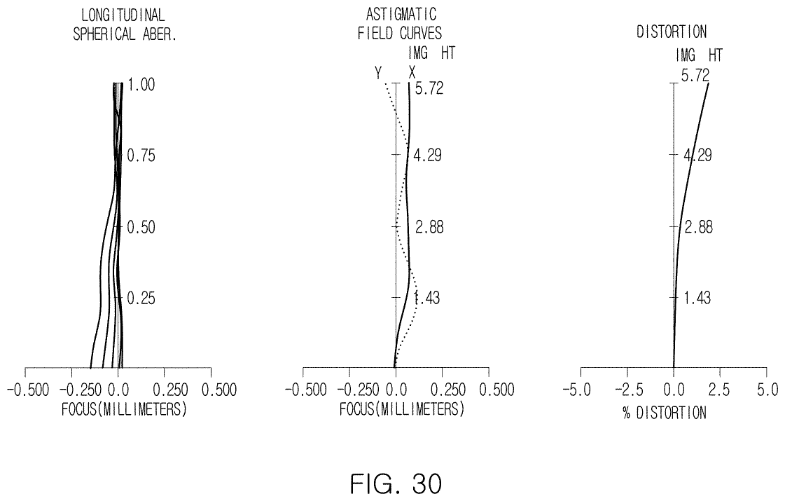

FIGS. 29 and 30 illustrate aberration curves of the imaging lens system according to the tenth embodiment.

Tables 19 and 20 below illustrate the lens characteristics and aspherical values of the imaging lens system according to the tenth embodiment.

TABLE 19

| | | | Thickness/ | Thickness/ | | |
|---|---|---|---|---|---|---|
| | | | Distance | Distance | | |
| Surface | | Radius of | (Wide-Angle | (Telephoto | Refractive | Abbe |
| No. | Component | Curvature | Mode) | Mode) | Index | No. |
| S1 | Prism | Infinity | 4.1500 | 4.1500 | 1.784 | 25.70 |
| S2 | | Infinity | 4.1500 | 4.1500 | 1.784 | 25.70 |
| S3 | | Infinity | 1.5000 | 1.5000 | | |
| S4 | 1st Lens | 22.6495 | 0.6200 | 0.6200 | 1.567 | 37.30 |
| S5 | | 10.0157 | 0.1000 | 0.1000 | | |
| S6 | 2nd Lens | 12.2762 | 0.7860 | 0.7860 | 1.671 | 19.20 |
| S7 | | 15.4544 | 6.6264 | 1.0662 | | |
| S8 | 3rd Lens | 7.0100 | 2.6000 | 2.6000 | 1.497 | 81.50 |
| S9 | | −43.4655 | 2.0081 | 2.0081 | | |
| S10 | 4th Lens | −63.4880 | 1.2073 | 1.2073 | 1.544 | 56.00 |
| S11 | | −9.2994 | 0.1800 | 0.1800 | | |
| S12 | 5th Lens | −6.4474 | 1.0000 | 1.0000 | 1.821 | 24.00 |
| S13 | | −10.0173 | 4.2642 | 1.7600 | | |
| S14 | 6th Lens | −10.1000 | 0.6200 | 0.6200 | 1.671 | 19.20 |
| S15 | | −14.0148 | 1.2778 | 1.2778 | | |
| S16 | 7th Lens | −877.7022 | 1.0064 | 1.0064 | 1.671 | 19.20 |
| S17 | | −20.9007 | 0.5000 | 0.5000 | | |
| S18 | 8th Lens | −40.2194 | 0.7500 | 0.7500 | 1.544 | 56.00 |
| S19 | | 7.8540 | 3.7765 | 11.8436 | | |
| S20 | Filter | Infinity | 0.2100 | 0.2100 | 1.516 | 64.10 |
| S21 | | Infinity | 0.9622 | 0.9700 | | |
| S22 | Imaging | Infinity | 0.0053 | −0.0053 | | |
| | Plane | | | | | |

TABLE 20

| Surface No. | S4 | S5 | S6 | S7 | S8 | S9 | S10 | S11 |
|---|---|---|---|---|---|---|---|---|
| k | 2.214E+00 | −2.286E+00 | −1.385E−01 | 3.440E+00 | −3.015E−01 | −9.900E+01 | 9.900E+01 | −3.955E+00 |
| A | −4.072E−01 | −2.708E−01 | 8.721E−03 | −6.684E−02 | 1.825E−04 | 8.803E−04 | −1.910E−01 | −2.352E−01 |
| B | 5.441E−02 | 4.544E−02 | −5.809E−03 | −9.859E−03 | 2.828E−05 | −2.037E−05 | −3.442E−02 | −5.793E−02 |
| C | −6.874E−03 | −1.112E−02 | −1.551E−03 | −3.301E−03 | −9.913E−06 | −1.352E−05 | 1.599E−02 | 1.697E−02 |
| D | −5.734E−04 | −7.099E−03 | −9.601E−04 | 1.318E−04 | 1.829E−06 | 3.244E−06 | −4.626E−03 | −3.156E−03 |
| E | −2.033E−04 | −3.333E−03 | −4.821E−04 | −6.387E−04 | −2.073E−07 | −4.178E−07 | 3.425E−04 | −6.470E−04 |
| F | −3.051E−04 | −2.520E−03 | −6.396E−04 | −2.694E−04 | 1.425E−08 | 3.297E−08 | 5.404E−04 | 3.677E−04 |
| G | −1.725E−04 | −7.443E−04 | 2.802E−04 | −6.487E−05 | −5.763E−10 | −1.559E−09 | −4.677E−06 | −3.871E−06 |
| H | −3.711E−05 | −8.279E−04 | −3.509E−04 | −1.216E−04 | 1.238E−11 | 3.983E−11 | −3.681E−05 | −2.235E−04 |
| J | −5.698E−05 | −3.386E−05 | −1.450E−05 | −2.773E−05 | −1.089E−13 | −4.173E−13 | −4.270E−05 | −3.276E−05 |

| Surface No. | S12 | S13 | S14 | S15 | S16 | S17 | S18 | S19 |
|---|---|---|---|---|---|---|---|---|
| k | −2.430E+01 | −6.127E+01 | −9.900E+01 | −9.900E+01 | −9.900E+01 | 2.800E+01 | 9.900E+01 | −5.244E+01 |
| A | −7.289E−03 | −4.665E−03 | 4.375E−01 | 7.231E−01 | −1.870E−01 | −4.009E−01 | −8.731E−01 | −1.002E+00 |
| B | 2.482E−03 | 1.769E−03 | −3.581E−03 | −1.757E−02 | 8.976E−02 | 7.086E−02 | 2.618E−01 | 4.937E−02 |
| C | −4.366E−04 | −2.889E−04 | −9.665E−03 | −2.005E−03 | 2.929E−02 | −1.963E−02 | −2.378E−02 | 2.215E−01 |
| D | 5.122E−05 | 2.780E−05 | 5.870E−03 | 4.901E−03 | 1.032E−02 | 1.980E−02 | 3.345E−02 | 3.358E−02 |
| E | −4.406E−06 | −9.734E−07 | −2.557E−03 | −1.768E−03 | −1.887E−02 | −3.498E−03 | −9.093E−03 | −2.892E−02 |
| F | 2.646E−07 | −1.272E−07 | 5.866E−04 | −1.876E−04 | −1.641E−04 | 2.317E−03 | −8.970E−04 | −3.053E−02 |
| G | −9.809E−09 | 1.892E−08 | −1.341E−04 | 1.248E−04 | 1.261E−03 | 3.678E−04 | −8.170E−03 | −3.376E−03 |
| H | 1.855E−10 | −9.806E−10 | 4.739E−06 | −1.197E−04 | 1.577E−03 | 5.402E−05 | −2.650E−03 | −1.144E−03 |
| J | −1.174E−12 | 1.865E−11 | 1.479E−05 | 5.375E−05 | 8.842E−04 | 2.954E−05 | −1.199E−03 | 2.055E−03 |

Tables 21 to 26 below illustrate optical characteristic values and conditional expression values of the imaging lens system according to the first to tenth embodiments. In Table 21 below, fw is a focal length of the imaging lens system in a wide-angle mode of the imaging lens system, and it is a focal length of the imaging lens system in a telephoto mode of the imaging lens system.

TABLE 21

| Optical | 1st | 2nd | 3rd | 4th | 5th |
|---|---|---|---|---|---|
| Characteristic | Emb. | Emb. | Emb. | Emb. | Emb. |
| fw | 18.70 | 18.70 | 18.70 | 18.70 | 18.70 |
| F number | 2.50 | 2.50 | 2.40 | 2.40 | 2.40 |
| ft | 28.00 | 28.00 | 28.00 | 28.00 | 28.00 |
| F number | 3.40 | 3.40 | 3.30 | 3.30 | 3.30 |
| fG1 | −32.89 | −30.82 | −32.47 | −33.04 | −33.56 |
| fG2 | 10.93 | 11.15 | 10.98 | 11.04 | 11.02 |
| fG3 | −13.31 | −15.44 | −13.72 | −13.69 | −13.40 |
| f1 | −22.948 | −21.527 | −22.562 | −23.020 | −23.436 |
| f2 | 69.465 | 64.552 | 68.327 | 70.330 | 71.783 |
| f3 | 10.788 | 10.730 | 10.705 | 10.721 | 10.739 |
| f4 | 16.478 | 17.035 | 19.973 | 19.328 | 18.438 |
| f5 | −20.645 | −18.873 | −22.480 | −21.452 | −21.256 |
| f6 | −22.519 | −19.734 | −28.629 | −26.950 | −26.919 |
| f7 | 18.005 | 18.324 | 20.096 | 19.187 | 19.231 |
| f8 | −11.879 | −14.593 | −11.707 | −11.610 | −11.444 |
| Optical | 6th | 7th | 8th | 9th | 10th |
| Characteristic | Emb. | Emb. | Emb. | Emb. | Emb. |
| fw | 18.70 | 18.70 | 18.70 | 18.70 | 18.70 |
| F number | 2.40 | 2.40 | 2.40 | 2.40 | 2.50 |
| ft | 28.00 | 28.00 | 28.00 | 30.00 | 30.00 |
| F number | 3.30 | 3.30 | 3.30 | 3.40 | 3.70 |
| fG1 | −33.34 | −33.20 | −31.74 | −36.20 | −51.48 |
| fG2 | 11.09 | 11.06 | 11.05 | 11.14 | 12.05 |
| fG3 | −13.69 | −13.87 | −14.40 | −13.81 | −14.04 |
| f1 | −21.860 | −21.860 | −22.045 | −26.594 | −32.079 |
| f2 | 59.186 | 59.186 | 65.971 | 85.673 | 80.178 |
| f3 | 10.625 | 10.625 | 10.594 | 10.785 | 12.327 |
| f4 | 16.403 | 16.403 | 18.384 | 19.856 | 19.807 |
| f5 | −18.274 | −18.274 | −19.818 | −21.394 | −25.045 |
| f6 | −29.719 | −29.719 | −32.290 | −38.779 | −57.061 |
| f7 | 19.596 | 19.596 | 20.702 | 22.467 | 31.613 |
| f8 | −11.276 | −11.276 | −11.682 | −11.171 | −11.973 |

TABLE 22

| Conditional | 1st | 2nd | 3rd | 4th | 5th |
|---|---|---|---|---|---|
| Expression | Emb. | Emb. | Emb. | Emb. | Emb. |
| fw/f6 | −0.8304 | −0.9476 | −0.6532 | −0.6939 | −0.6947 |
| fw/f7 | 1.0386 | 1.0205 | 0.9305 | 0.9746 | 0.9724 |
| fw/f8 | −1.5742 | −1.2815 | −1.5974 | −1.6107 | −1.6341 |
| Nd3 | 1.4970 | 1.4970 | 1.4970 | 1.4970 | 1.4970 |
| fw/R10 | −1.9568 | −1.7151 | −1.9316 | −1.9623 | −2.0134 |
| fw/R14 | −1.7222 | −0.2196 | −1.3839 | −1.3444 | −1.3892 |
| TTL/2lmgHT | 2.5087 | 2.5087 | 2.4913 | 2.4913 | 2.4913 |
| BFLw/2lmgHT | 0.4341 | 0.4494 | 0.4432 | 0.4409 | 0.4428 |
| TTL/fw | 1.5348 | 1.5348 | 1.5241 | 1.5241 | 1.5241 |
| Conditional | 6th | 7th | 8th | 9th | 10th |
| Expression | Emb. | Emb. | Emb. | Emb. | Emb. |
| fw/f6 | −0.6292 | −0.6292 | −0.5791 | −0.4822 | −0.3277 |
| fw/f7 | 0.9543 | 0.9543 | 0.9033 | 0.8323 | 0.5915 |
| fw/f8 | −1.6583 | −1.6583 | −1.6007 | −1.6740 | −1.5618 |
| Nd3 | 1.4970 | 1.4970 | 1.4970 | 1.4970 | 1.4970 |
| fw/R10 | −2.0116 | −2.0082 | −2.1448 | −1.7998 | −1.8668 |
| fw/R14 | −1.4511 | −0.8458 | −1.0518 | −1.1601 | −0.8947 |
| TTL/2lmgHT | 2.4913 | 2.4913 | 2.4913 | 2.4913 | 2.4913 |
| BFLw/2lmgHT | 0.4481 | 0.4410 | 0.4562 | 0.4284 | 0.4330 |
| TTL/fw | 1.5241 | 1.5241 | 1.5241 | 1.5241 | 1.5241 |

TABLE 23

| Conditional | 1st | 2nd | 3rd | 4th | 5th |
|---|---|---|---|---|---|
| Expression | Emb. | Emb. | Emb. | Emb. | Emb. |
| fG1F/fG2F | −2.1272 | −2.0062 | −2.1075 | −2.1472 | −2.1823 |
| fG1F/fG3F | 1.0190 | 1.0909 | 0.7881 | 0.8542 | 0.8706 |
| fG2F/fG3F | −0.4790 | −0.5437 | −0.3739 | −0.3978 | −0.3989 |
| fG1R/fG2R | −3.3648 | −3.4203 | −3.0394 | −3.2785 | −3.3770 |
| fG1R/fG3R | −5.8477 | −4.4236 | −5.8366 | −6.0578 | −6.2726 |
| fG2R/fG3R | 1.7379 | 1.2934 | 1.9203 | 1.8477 | 1.8575 |
| Conditional | 6th | 7th | 8th | 9th | 10th |
| Expression | Emb. | Emb. | Emb. | Emb. | Emb. |
| fG1F/fG2F | −2.0575 | −2.0575 | −2.0809 | −2.4659 | −2.6023 |
| fG1F/fG3F | 0.7355 | 0.7355 | 0.6827 | 0.6858 | 0.5622 |
| fG2F/fG3F | −0.3575 | −0.3575 | −0.3281 | −0.2781 | −0.2160 |
| fG1R/fG2R | −3.2388 | −3.2388 | −3.3288 | −4.0045 | −3.2014 |
| fG1R/fG3R | −5.2487 | −5.2487 | −5.6471 | −7.6694 | −6.6964 |
| fG2R/fG3R | 1.6206 | 1.6206 | 1.6964 | 1.9152 | 2.0917 |

TABLE 24

| Conditional | 1st | 2nd | 3rd | 4th | 5th |
|---|---|---|---|---|---|
| Expression | Emb. | Emb. | Emb. | Emb. | Emb. |
| RG1F/RG2F | 1.9804 | 2.8064 | 6.6815 | 6.5517 | 5.6978 |
| RG1F/RG3F | −0.9461 | −0.8259 | −1.8434 | −1.9192 | −2.6406 |
| RG2F/RG3F | −0.4778 | −0.2943 | −0.2759 | −0.2929 | −0.4634 |
| rG1R/rG2R | −1.4869 | −1.1294 | −1.4210 | −1.4394 | −1.4808 |
| rG1R/rG3R | 2.1861 | 1.8492 | 1.8120 | 1.8232 | 1.8577 |
| rG2R/rG3R | −1.4702 | −1.6374 | −1.2752 | −1.2666 | −1.2546 |
| Conditional | 6th | 7th | 8th | 9th | 10th |
| Expression | Emb. | Emb. | Emb. | Emb. | Emb. |
| RG1F/RG2F | 5.6805 | 4.6270 | 3.3475 | 1.6987 | 3.2310 |
| RG1F/RG3F | −2.6392 | −2.2959 | −0.8389 | −1.0452 | −2.2425 |
| RG2F/RG3F | −0.4646 | −0.4962 | −0.2506 | −0.6153 | −0.6941 |
| rG1R/rG2R | −1.5794 | −1.3405 | −1.5460 | −0.9532 | −1.5428 |
| rG1R/rG3R | 2.0171 | 1.6198 | 1.7682 | 1.3714 | 1.9677 |
| rG2R/rG3R | −1.2771 | −1.2084 | −1.1437 | −1.4388 | −1.2754 |

TABLE 25

| Conditional | 1st | 2nd | 3rd | 4th | 5th |
|---|---|---|---|---|---|
| Expression | Emb. | Emb. | Emb. | Emb. | Emb. |
| (R2 + R3)/R4 | 1.3514 | 1.5492 | 1.7390 | 1.7553 | 1.7264 |
| (R5 + R6)/R7 | 0.2460 | 0.2782 | 0.2893 | 0.2851 | 0.2897 |
| (R8 + R9)/R10 | 1.3721 | 1.2550 | 1.5311 | 1.5187 | 1.5068 |
| Conditional | 6th | 7th | 8th | 9th | 10th |
| Expression | Emb. | Emb. | Emb. | Emb. | Emb. |
| (R2 + R3)/R4 | 1.5769 | 1.7240 | 1.5293 | 1.6343 | 1.4424 |
| (R5 + R6)/R7 | 0.2658 | 0.2669 | 0.2499 | 0.2691 | 0.5742 |
| (R8 + R9)/R10 | 1.3886 | 1.4402 | 1.5716 | 1.4608 | 1.5720 |

TABLE 26

| Conditional | 1st | 2nd | 3rd | 4th | 5th |
|---|---|---|---|---|---|
| Expression | Emb. | Emb. | Emb. | Emb. | Emb. |
| fG1/fG2 | −3.0106 | −2.7634 | −2.9559 | −2.9930 | −3.0444 |
| fG3/fG2 | −1.2178 | −1.3844 | −1.2496 | −1.2401 | −1.2152 |
| fG1/fG3 | 2.4721 | 1.9960 | 2.3656 | 2.4134 | 2.5053 |
| (fG1 + fG2)/fG3 | 1.6510 | 1.2737 | 1.5653 | 1.6071 | 1.6824 |
| Conditional | 6th | 7th | 8th | 9th | 10th |
| Expression | Emb. | Emb. | Emb. | Emb. | Emb. |
| fG1/fG2 | −3.0069 | −3.0014 | −2.8718 | −3.2500 | −4.2708 |
| fG3/fG2 | −1.2348 | −1.2539 | −1.3028 | −1.2401 | −1.1647 |
| fG1/fG3 | 2.4352 | 2.3938 | 2.2044 | 2.6208 | 3.6669 |
| (fG1 + fG2)/fG3 | 1.6253 | 1.5962 | 1.4368 | 1.8144 | 2.8083 |

The imaging lens system according to the present embodiment may have specific numerical ranges for the focal lengths of the first to eighth lenses. For example, a focal length of the first lens may be determined in a range of −36.0 mm to −20.0 mm, a focal length of the second lens may be determined in a range of 50 mm to 90 mm, a focal length of the third lens may be determined in a range of 8.0 mm to 16.0 mm, a focal length of the fourth lens may be determined in a range of 12.0 mm to 24.0 mm, a focal length of the fifth lens may be determined in a range of −30.0 mm to −12.0 mm, a focal length of the sixth lens may be determined in a range of −60 mm to −12.0 mm, a focal length of the seventh lens may be determined in a range of 16.0 mm to 36.0 mm, and a focal length of the eighth lens may be determined in a range of −20.0 mm to −8.0 mm.

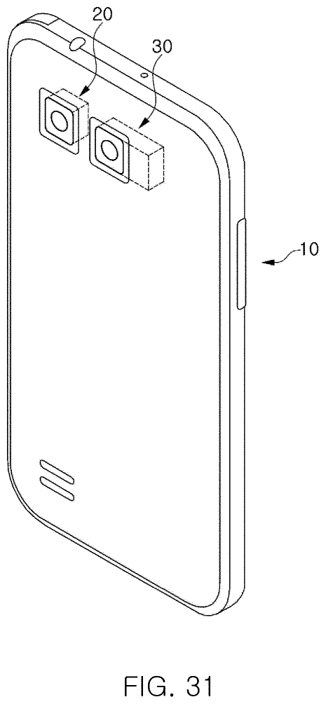

FIG. 31 is a diagram of an electronic device in which an imaging lens system according to an embodiment of the present disclosure is mounted.

Referring to FIG. 31, an electronic device 10 according to an embodiment of the present disclosure may include a camera module. For example, the electronic device 10 may be a portable terminal including a camera module (20, 30). However, the form of the electronic device 10 may not limited to a portable terminal. For example, the electronic device 10 may be any portable electronic device such as a laptop, a tablet PC, or any other portable electronic device. Either one or both of the camera modules (20, 30) may be any one of the imaging lens systems (100, 200, 300, 400, 500, 600, 700, 800, 900, 1000) according to the first to tenth embodiments.

The present disclosure can provide an imaging lens system capable of improving a resolution in a peripheral portion of the imaging plane.

While this disclosure includes specific examples, it will be apparent after an understanding of the disclosure of this application that various changes in form and details may be made in these examples without departing from the spirit and scope of the claims and their equivalents. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An imaging lens system comprising:
a first lens group comprising a first lens and a second lens;
a second lens group comprising a third lens, a fourth lens, and a fifth lens; and
a third lens group comprising a sixth lens, a seventh lens, and an eighth lens;
wherein the first lens group to the third lens group are sequentially arranged in ascending numerical order along an optical axis of the imaging lens system from an object side of the imaging lens system toward an imaging plane of the imaging lens system, and
the imaging lens system satisfies the following conditional expression:
2.0<TTL/2 ImgHT<3.0
where TTL is a distance along the optical axis from an object-side surface of the first lens to the imaging plane, and 2ImgHT is a diagonal length of the imaging plane.

2. The imaging lens system of claim 1, wherein the object-side surface of the first lens is convex in a paraxial region thereof.

3. The imaging lens system of claim 1, wherein the second lens has a convex object-side surface in a paraxial region thereof.

4. The imaging lens system of claim 1, wherein the third lens has a convex object-side surface in a paraxial region thereof.

5. The imaging lens system of claim 1, wherein the fourth lens has a concave object-side surface in a paraxial region thereof.

6. The imaging lens system of claim 1, wherein the fifth lens has a concave object-side surface in a paraxial region thereof.

7. The imaging lens system of claim 1, wherein the sixth lens has a concave object-side surface in a paraxial region thereof.

8. The imaging lens system of claim 1, wherein the eighth lens has a concave object-side surface in a paraxial region thereof.

9. An imaging lens system comprising:
a first lens, a second lens, a third lens, a fourth lens, a fifth lens, a sixth lens, a seventh lens, and an eighth lens sequentially arranged in ascending numerical order along an optical axis of the imaging lens system from an object side of the imaging lens system toward an imaging plane of the imaging lens system,
wherein the first lens and the eighth lens each have a negative refractive power, and
the imaging lens system satisfies the following conditional expression:
2.0<TTL/2ImgHT <3.0
where TTL is a distance along the optical axis from an object-side surface of the first lens to the imaging plane, and 2ImgHT is a diagonal length of the imaging plane.

10. The imaging lens system of claim 9, wherein the object-side surface of the first lens is convex in a paraxial region thereof.

11. The imaging lens system of claim 9, wherein the second lens has a convex object-side surface in a paraxial region thereof.

12. The imaging lens system of claim 9, wherein the third lens has a convex object-side surface in a paraxial region thereof.

13. The imaging lens system of claim 9, wherein the fourth lens has a concave object-side surface in a paraxial region thereof.

14. The imaging lens system of claim 9, wherein the fifth lens has a concave object-side surface in a paraxial region thereof.

15. The imaging lens system of claim 9, wherein the sixth lens has a concave object-side surface in a paraxial region thereof.

16. The imaging lens system of claim 9, wherein the eighth lens has a concave object-side surface in a paraxial region thereof.
